(19) United States
(12) Patent Application Publication
(10) Pub. No.: US 2024/0284206 A1
(43) Pub. Date: Aug. 22, 2024

(54) SYNCHRONIZATION SIGNAL BLOCK PROCEDURES BASED ON NETWORK POWER SAVINGS

(71) Applicant: QUALCOMM Incorporated, San Diego, CA (US)

(72) Inventors: Ahmed Elshafie, San Diego, CA (US); Marwen Zorgui, San Diego, CA (US); Diana Maamari, San Diego, CA (US); Ahmed Attia Abotabl, San Diego, CA (US)

(21) Appl. No.: 18/172,167

(22) Filed: Feb. 21, 2023

(51) Int. Cl. H04W 24/08

(52) U.S. Cl. CPC H04W 24/08

(57) ABSTRACT

Methods, systems, and devices for wireless communications are described. In some systems, a network may support different network energy states (NESs). A network entity may transmit, for a user equipment (UE), an indication of a currently active NES, for example, for a serving cell or for a non-serving cell. The UE may determine a radio measurement threshold, a relaxation configuration, or both based on the active NES for the network entity. A network entity associated with the serving cell or non-serving cell may transmit a synchronization signal block (SSB) using one or more parameters associated with the active NES, and the UE may receive the SSB and perform one or more measurements based on the active NES (e.g., based on the radio measurement threshold, the relaxation configuration, or both). The UE may communicate with the network based on the one or more measurements.

### INTRODUCTION

The following relates to wireless communications, including network power saving procedures.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

An apparatus for wireless communications at a UE is described. The apparatus may include a processor and memory coupled with the processor. The processor may be configured to receive, for a network entity, a first indication of an active network energy state (NES) from a set of multiple NESs. In some examples, the processor may be further configured to receive a synchronization signal block (SSB) for the network entity based on the active NES and communicate based on one or more measurements associated with the SSB.

A method for wireless communications at a UE is described. The method may include receiving, for a network entity, a first indication of an active NES from a set of multiple NESs. In some examples, the method may further include receiving an SSB for the network entity based on the active NES and communicating based on one or more measurements associated with the SSB.

Another apparatus for wireless communications at a UE is described. The apparatus may include means for receiving, for a network entity, a first indication of an active NES from a set of multiple NESs. In some examples, the apparatus may further include means for receiving an SSB for the network entity based on the active NES and means for communicating based on one or more measurements associated with the SSB.

A non-transitory computer-readable medium storing code for wireless communications at a UE is described. The code may include instructions executable by a processor to receive, for a network entity, a first indication of an active NES from a set of multiple NESs. In some examples, the code may further include instructions executable by the processor to receive an SSB for the network entity based on the active NES and communicate based on one or more measurements associated with the SSB.

Some examples of the method, apparatuses, and non-transitory computer-readable medium described herein may further include operations, features, means, or instructions for receiving a second indication of a correction factor that corresponds to the active NES and determining a radio measurement threshold based on the correction factor, the communication further based on the radio measurement threshold.

In some examples of the method, apparatuses, and non-transitory computer-readable medium described herein, to determine the radio measurement threshold, the method, apparatuses, and non-transitory computer-readable medium described herein may include operations, features, means, or instructions for setting the radio measurement threshold to a value of the correction factor or modifying the radio measurement threshold in accordance with the value of the correction factor.

Some examples of the method, apparatuses, and non-transitory computer-readable medium described herein may further include operations, features, means, or instructions for receiving a first signal that indicates a list of correction factors and receiving a second signal that includes the second indication of the correction factor from the list of correction factors.

In some examples of the method, apparatuses, and non-transitory computer-readable medium described herein, the first signal includes a radio resource control (RRC) signal, a master information block (MIB), a system information block (SIB), a random access channel (RACH) signal, or a combination thereof. In some examples of the method, apparatuses, and non-transitory computer-readable medium described herein, the second signal includes a medium access channel element (MAC-CE), a downlink control information (DCI) signal, or both. In some examples of the method, apparatuses, and non-transitory computer-readable medium described herein, the radio measurement threshold includes a reference signal received power (RSRP) threshold, a reference signal received quality (RSRQ) threshold, or both.

Some examples of the method, apparatuses, and non-transitory computer-readable medium described herein may further include operations, features, means, or instructions for receiving the SSB based on a periodicity for SSBs, a skipping pattern for the SSBs, a first set of SSB occasions to skip, a second set of SSB occasions to receive, or a combination thereof that corresponds to the active NES.

Some examples of the method, apparatuses, and non-transitory computer-readable medium described herein may further include operations, features, means, or instructions for determining a radio resource management (RRM) relaxation configuration, an RRM relaxation factor, or both based on the active NES and the periodicity for SSBs, the skipping pattern for the SSBs, the first set of SSB occasions to skip, the second set of SSB occasions to receive, or the combination thereof based on the RRM relaxation configuration, the RRM relaxation factor, or both.

Some examples of the method, apparatuses, and non-transitory computer-readable medium described herein may further include operations, features, means, or instructions for transmitting UE information. In some examples of the method, apparatuses, and non-transitory computer-readable medium described herein, the active NES, a radio measurement configuration for the network entity, or both may be based on the UE information. In some examples of the method, apparatuses, and non-transitory computer-readable medium described herein, the UE information includes a UE capability, a UE type, UE mobility information, a UE power state, a power saving mode, a sleep mode, an RRC state, or a combination thereof.

Some examples of the method, apparatuses, and non-transitory computer-readable medium described herein may further include operations, features, means, or instructions for transmitting a third indication of a relaxed measurement configuration for the UE. In some examples of the method, apparatuses, and non-transitory computer-readable medium described herein, the active NES, a radio measurement configuration for the network entity, or both may be based on the relaxed measurement configuration for the UE.

Some examples of the method, apparatuses, and non-transitory computer-readable medium described herein may further include operations, features, means, or instructions for transmitting a request for an RRM relaxation configuration, an RRM relaxation factor, or both for the network entity. In some examples of the method, apparatuses, and non-transitory computer-readable medium described herein, the active NES, a radio measurement configuration for the network entity, or both may be based on the request.

In some examples of the method, apparatuses, and non-transitory computer-readable medium described herein, the active NES indicates a quantity of active antennas, a transmit power, or both for the network entity. In some examples of the method, apparatuses, and non-transitory computer-readable medium described herein, the network entity includes a serving network entity. In some other examples of the method, apparatuses, and non-transitory computer-readable medium described herein, the network entity includes a non-serving network entity and the first indication of the active NES for the non-serving network entity may be received from a serving network entity.

An apparatus for wireless communications is described. The apparatus may include a processor and memory coupled with the processor. The processor may be configured to output, for a UE, a first indication of an active NES for a network entity from a set of multiple NESs. In some examples, the processor may be further configured to output an SSB for the network entity based on the active NES and communicate based on the SSB.

A method for wireless communications is described. The method may include outputting, for a UE, a first indication of an active NES for a network entity from a set of multiple NESs. In some examples, the method may further include outputting an SSB for the network entity based on the active NES and communicating based on the SSB.

Another apparatus for wireless communications is described. The apparatus may include means for outputting, for a UE, a first indication of an active NES for a network entity from a set of multiple NESs. In some examples, the apparatus may further include means for outputting an SSB for the network entity based on the active NES and means for communicating based on the SSB.

A non-transitory computer-readable medium storing code for wireless communications is described. The code may include instructions executable by a processor to output, for a UE, a first indication of an active NES for a network entity from a set of multiple NESs. In some examples, the code may further include instructions executable by the processor to output an SSB for the network entity based on the active NES and communicate based on the SSB.

Some examples of the method, apparatuses, and non-transitory computer-readable medium described herein may further include operations, features, means, or instructions for outputting, for the UE, a second indication of a correction factor for a radio measurement threshold that corresponds to the active NES.

Some examples of the method, apparatuses, and non-transitory computer-readable medium described herein may further include operations, features, means, or instructions for outputting, for the UE, a first signal that indicates a list of correction factors and outputting, for the UE, a second signal that includes the second indication of the correction factor from the list of correction factors.

In some examples of the method, apparatuses, and non-transitory computer-readable medium described herein, the UE includes a first UE and the list of correction factors includes a first list of a first list size. Some examples of the method, apparatuses, and non-transitory computer-readable medium described herein may further include operations, features, means, or instructions for outputting, for a second UE, a third signal that indicates a second list of correction factors of a second list size different from the first list size.

In some examples of the method, apparatuses, and non-transitory computer-readable medium described herein, the first signal includes an RRC signal, a MIB, a SIB, a RACH signal, or a combination thereof. In some examples of the method, apparatuses, and non-transitory computer-readable medium described herein, the second signal includes a MAC-CE, a DCI signal, or both.

In some examples of the method, apparatuses, and non-transitory computer-readable medium described herein, to output the SSB, the method, apparatuses, and non-transitory computer-readable medium described herein may include operations, features, means, or instructions for outputting the SSB based on a periodicity for SSBs, a skipping pattern for the SSBs, a first set of SSB occasions to skip, a second set of SSB occasions to transmit, or a combination thereof that corresponds to the active NES.

Some examples of the method, apparatuses, and non-transitory computer-readable medium described herein may further include operations, features, means, or instructions for obtaining UE information for the UE and determining the active NES, a radio measurement configuration for the network entity, or both based on the UE information.

In some examples of the method, apparatuses, and non-transitory computer-readable medium described herein, the UE information includes a UE capability, a UE type, UE mobility information, a UE power state, a power saving mode, a sleep mode, an RRC state, or a combination thereof.

Some examples of the method, apparatuses, and non-transitory computer-readable medium described herein may further include operations, features, means, or instructions for obtaining a third indication of a relaxed measurement configuration for the UE and determining the active NES, a radio measurement configuration for the network entity, or both based on the relaxed measurement configuration for the UE.

Some examples of the method, apparatuses, and non-transitory computer-readable medium described herein may further include operations, features, means, or instructions for obtaining a request for an RRM relaxation configuration, an RRM relaxation factor, or both for the network entity and determining the active NES, a radio measurement configuration for the network entity, or both based on the request.

Some examples of the method, apparatuses, and non-transitory computer-readable medium described herein may further include operations, features, means, or instructions for determining a quantity of active antennas, a transmit power, or both for the network entity based on the active NES.

Some examples of the method, apparatuses, and non-transitory computer-readable medium described herein may further include operations, features, means, or instructions for obtaining, for a second network entity, a second active NES, a correction factor for a radio measurement threshold that corresponds to the second network entity, or both. Some examples of the method, apparatuses, and non-transitory computer-readable medium described herein may further include operations, features, means, or instructions for outputting, for the UE, a fourth indication of the second active NES, the correction factor, or both for the second network entity, where the second network entity includes a non-serving network entity for the UE.

Some examples of the method, apparatuses, and non-transitory computer-readable medium described herein may further include operations, features, means, or instructions for outputting, for a second network entity, the active NES, a correction factor for a radio measurement threshold that corresponds to the network entity, or both.

### BRIEF DESCRIPTION OF THE DRAWINGS

FIG. 1 illustrates an example of a wireless communications system that supports SSB procedures based on network power savings in accordance with one or more aspects of the present disclosure.

FIG. 2 illustrates an example of a network architecture that supports SSB procedures based on network power savings in accordance with one or more aspects of the present disclosure.

FIG. 3 illustrates an example of a wireless communications system that supports SSB procedures based on network power savings in accordance with one or more aspects of the present disclosure.

FIG. 4 illustrates an example of relaxation configurations that support SSB procedures based on network power savings in accordance with one or more aspects of the present disclosure.

FIG. 5 illustrates an example of a process flow that supports SSB procedures based on network power savings in accordance with one or more aspects of the present disclosure.

FIGS. 6 and 7 illustrate block diagrams of devices that support SSB procedures based on network power savings in accordance with one or more aspects of the present disclosure.

FIG. 8 illustrates a block diagram of a communications manager that supports SSB procedures based on network power savings in accordance with one or more aspects of the present disclosure.

FIG. 9 illustrates a diagram of a system including a device that supports SSB procedures based on network power savings in accordance with one or more aspects of the present disclosure.

FIGS. 10 and 11 illustrate block diagrams of devices that support SSB procedures based on network power savings in accordance with one or more aspects of the present disclosure.

FIG. 12 illustrates a block diagram of a communications manager that supports SSB procedures based on network power savings in accordance with one or more aspects of the present disclosure.

FIG. 13 illustrates a diagram of a system including a device that supports SSB procedures based on network power savings in accordance with one or more aspects of the present disclosure.

FIGS. 14 through 17 illustrate flowcharts showing methods that support SSB procedures based on network power savings in accordance with one or more aspects of the present disclosure.

### DETAILED DESCRIPTION

In some wireless communications systems, a network entity may support network power saving procedures. The network entity may switch between different active NESs to trigger corresponding network power saving procedures. As described herein, an active NES may be a current NES (or network power state or network power mode) activated for a specific cell, a specific network entity, or both. A network entity may support multiple NESs, where each NES corresponds to a specific network power saving configuration, specific network power saving techniques, or both. For example, a NES may define or otherwise indicate a relaxation configuration for the network entity or UEs served by the network entity, a subset of antenna ports to use for communications (e.g., transmit antenna ports, receive antenna ports), a transmit power to use for signals (e.g., SSBs), or any combination thereof. The network entity may switch between different active NESs based on power availability at the network entity, quantities or capabilities of UEs served by the network entity, or a combination thereof. According to one or more examples, network entity may operate according to one active NES at a time.

In some examples, the network entity may improve a processing overhead associated with transmissions, such as SSB transmissions, by using a specific transmission procedure. For example, a specific SSB transmission procedure may involve the network entity reducing the quantity of SSBs transmitted, reducing a transmit power associated with the SSB transmissions, reducing a quantity of active antenna ports for the SSB transmissions, or some combination thereof. An SSB may be an example of a signal supporting UE synchronization with a cell (e.g., a serving cell or a non-serving cell). A UE may perform one or more measurements using an SSB received at the UE. For example, the one or more measurements may include RSRP measurements, RSRQ measurements, or any other RRM or radio link monitoring (RLM) measurements for a cell. The measurements may support cell selection or reselection, synchronization (e.g., timing synchronization, frequency synchronization) with the cell, or some combination thereof. A currently active NES for the network entity may indicate the specific SSB transmission procedure for the network entity to use. Coordination of the active NES with one or more UEs may support the UEs performing similar power saving techniques for SSB monitoring, improved measurement accuracy, or both. For example, a UE may monitor for SSBs based on the specific SSB transmission procedure corresponding to the currently active NES. The UE may achieve UE power savings (e.g., similar to the network power savings) by monitoring for the reduced quantity of SSBs transmitted for the specific SSB transmission procedure. Additionally, or alternatively, the UE may perform accurate SSB measurements by accounting for the transmit power, quantity of active antenna ports, or both for the specific SSB transmission procedure.

As described herein, a network entity may output, for one or more UEs, an indication of an active NES from a set of multiple NESs configured for the network entity. In some cases, the indication of the active NES may be a field in a signal (e.g., a DCI signal, a MAC-CE, an RRC signal) including a bit value that indicates the active NES (e.g., based on a bit map or other configuration of multiple NESs supported by the network entity). According to one or more examples, the multiple NESs may correspond to different SSB transmission configurations at the network entity. A UE may receive the indication of the active NES, where the active NES corresponds to a serving cell or a non-serving cell (e.g., a neighboring cell) for the UE. Based on the indicated active NES, the UE may determine a radio measurement threshold, a relaxation configuration, or both for SSB measurements. A radio measurement threshold may be an example of any threshold value that the UE compares with an SSB measurement to determine whether to trigger an action (e.g., trigger a cell switch). A relaxation configuration may be an example of a configured procedure for reducing the power associated with SSB transmissions. A network entity may use a relaxation configuration to reduce a quantity of SSBs transmitted (e.g., skipping transmission occasions, increasing a periodicity between SSB transmissions), a UE may use a relaxation configuration to reduce a quantity of times the UE monitors for SSB transmissions, or both. A network entity associated with the serving cell or non-serving cell may transmit an SSB using one or more parameters associated with the active NES, and the UE may receive the SSB and perform one or more measurements based on the active NES (e.g., based on the radio measurement threshold, the relaxation configuration, or both). The radio measurement threshold, the relaxation configuration, or both may correspond to the active SSB transmission configuration at a network entity. For example, if the network entity transmits an SSB using a reduced transmit power, the UE may determine a modified radio measurement threshold for performing measurements to account for the reduced transmit power. Similarly, if the network entity skips an SSB transmission occasion, the UE may determine a relaxation configuration indicating to skip monitoring for an SSB in the skipped SSB transmission occasion. Accordingly, the network entity and the UE may coordinate power savings and SSB configurations based on the indication of the active NES (e.g., a bit value indicating the active NES). The UE may communicate with the network based on the one or more measurements.

Aspects of the subject matter described herein may be implemented by a device to support improved processing overhead, improved power consumption, and improved coordination associated with SSB transmissions. In some cases, a network entity may switch to a specific active NES to achieve power savings. For example, the network entity may improve a processing overhead and power consumption based on reducing a transmit power, a quantity of active antenna ports, or both for SSB transmissions. Additionally, or alternatively, the network entity may improve the processing overhead and power consumption based on reducing a quantity of SSB transmissions (e.g., based on skipping one or more SSB transmission occasions, based on increasing a periodicity between SSB transmissions). By transmitting an indication of the active NES to one or more UEs, the network entity may improve coordination between devices within the wireless network. A UE receiving the indication of the active NES may determine a radio measurement threshold, a relaxation configuration, or both for SSB measurements. The UE may improve a processing overhead, power consumption, and SSB measurement accuracy based on determining the radio measurement threshold, the relaxation configuration, or both. For example, by adjusting one or more radio measurement thresholds to account for a reduced SSB transmit power (e.g., lowering an SSB receive power threshold value associated with triggering a cell switch to account for the relatively lower transmit power used for the SSB transmission), the UE may improve SSB measurement accuracy and refrain from performing cell selection or reselection procedures potentially resulting from inaccurate measurements (e.g., measurements made assuming an inaccurate transmit power for the SSB transmission). Additionally, or alternatively, the UE may refrain from monitoring for an SSB during occasions in which the SSB transmission is skipped based on the determined relaxation configuration, improving the processing overhead, power consumption, and SSB measurement accuracy of the UE. In some examples, the network entity may transmit, to the UE, an indication of an active NES for a serving cell, one or more non-serving cells, or some combination thereof, improving the accuracy of cell selection or reselection procedures between the serving cell and the one or more non-serving cells for the UE.

As described herein, a correction factor may be an example of a scaling factor or other value that indicates an adjustment to a threshold (e.g., a radio measurement threshold, such as an RSRP or RSRQ threshold). For example, a UE may increase or decrease a threshold value by adding the correction factor to the threshold value, subtracting the correction factor from the threshold value, multiplying the correction factor by the threshold value, or setting the threshold value to the correction factor value. In some cases, an active NES may correspond to different correction factors corresponding to different respective radio measurement thresholds. In some examples, the network may configure the UE with a list of correction factors for a specific threshold, where the list may include multiple correction factors. The network may indicate a single correction factor from the list for the UE to use for the specific threshold. A relaxation configuration (e.g., an RRM or RLM relaxation configuration) may configure one or more power saving procedures at a UE, a network entity, or both. For example, a relaxation configuration may indicate a reduction in SSB monitoring at a UE. The relaxation configuration may indicate skipping for one or more SSBs. For example, a UE may be configured with a set of SSB monitoring occasions (e.g., based on a periodicity for monitoring a channel for SSBs). The periodicity for SSB monitoring occasions with no relaxation (e.g., not corresponding to a relaxation configuration at the UE) may be referred to as a “default” periodicity. The relaxation configuration may indicate a subset of the set of SSB monitoring occasions for the UE to “skip,” or otherwise refrain from monitoring for an SSB. The relaxation configuration may indicate specific SSB monitoring occasions, a pattern of SSB monitoring occasions (e.g., skipping every two occasions or every three occasions), or a combination thereof. Additionally, or alternatively, the relaxation configuration may indicate an update to the periodicity for SSB monitoring occasions. If the updated periodicity is longer than the default periodicity configured for the UE, the UE may conserve power by monitoring for SSBs relatively less frequently.

Aspects of the disclosure are initially described in the context of wireless communications systems. Additional aspects of the disclosure are described with reference to relaxation configurations and process flows. Aspects of the disclosure are further illustrated by and described with reference to apparatus diagrams, system diagrams, and flowcharts that relate to SSB procedures based on network power savings.

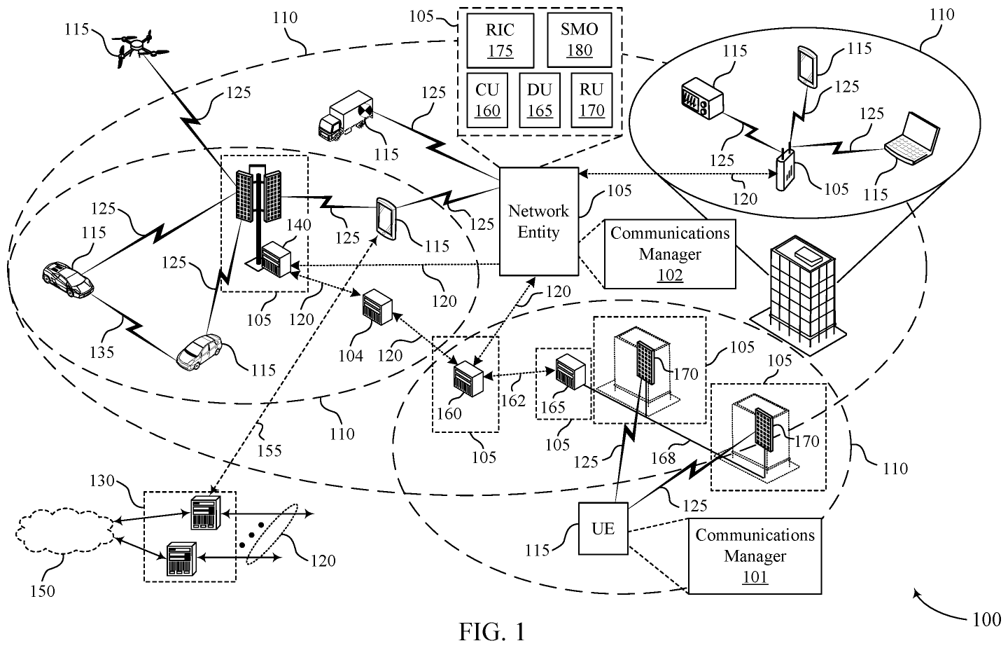

FIG. 1 illustrates an example of a wireless communications system 100 that supports SSB procedures based on network power savings in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support SSB procedures based on network power savings as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz may be known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, or FR5, or may be within the EHF band.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems 100, a UE 115 may support RRM relaxation procedures to conserve power (e.g., improve a processing overhead) at the UE 115. For example, the UE 115 may support one or more triggering criteria for entering an RRM relaxation mode. The UE 115 may relax measurements (e.g., perform relatively fewer measurements) for intra-frequency NR cells, inter-frequency NR cells, inter-RAT evolved universal mobile telecommunications system (UMTS) terrestrial radio access network (E-UTRAN) cells, or any combination of these or other cells based on configured triggering criteria.

A first triggering criterion for the RRM relaxation mode may involve low mobility at the UE 115. The UE 115 may be considered low mobility if the UE 115 satisfies Equation 1 for a period of T_{SearchDeltaP}, where T_{SearchDeltaP} is a time period for low mobility evaluation.

$$( {Srxlev}_{Ref} - Srxlev ) < {S}_{SearchDeltaP} , \qquad ( 1 )$$

Srxlev is a current cell selection receive level value (e.g., in decibels (dB)) for a signal (e.g., an SSB) received from a serving cell, Srxlev_{Ref} is a reference cell selection receive level value, and S_{SearchDeltaP} is a low mobility evaluation threshold for change in receive power (e.g., in dB). The UE 115 may set Srxlev_{Ref} equal to Srxlev when a new serving cell is selected or re-selected, Srxlev-Srxlev_{Ref}>0 (e.g., Srxlev is increasing), a relaxation triggering criterion is not met for a duration of T_{SearchDeltaP}, or some combination thereof.

A second triggering criterion for the RRM relaxation mode may involve the UE 115 not being located near a cell edge (e.g., the UE 115 being located relatively central to the cell). For example, the UE 115 may be located near the edge of a cell (e.g., near the edge of a coverage area 110 for a network entity 105) or may be located relatively central to the cell (e.g., not near the edge of the coverage area 110 for the network entity 105). The UE 115 may be considered not near a cell edge if the UE 115 satisfies Equation 2 (if S_{SearchThresholdP}, a cell edge evaluation power threshold, is configured), Equation 3 (if S_{searchThresholdQ}, a cell edge evaluation quality threshold, is configured), or both.

$$Srxlev > {S}_{SearchThresholdP} \qquad ( 2 )$$

$$Squal > {S}_{SearchThresholdQ} \qquad ( 3 )$$

That is, if the measured receive quality and receive power at a UE 115 satisfy (e.g., are greater than) respective thresholds, the UE 115 may determine that it is not near a cell edge (e.g., is relatively central to a cell). In some examples, a network entity 105 may configure one or both of these triggering criteria for a UE 115 to trigger RRM relaxation. Additionally, or alternatively, the network entity 105 may configure whether the UE 115 triggers RRM relaxation based on meeting any one trigger or based on meeting both—or each—configured trigger.

Additionally, or alternatively, the UE 115 may use one or more other triggering criteria for entering an RRM relaxation mode. For example, a reduced capability (Redcap) UE may support a Redcap UE stationary triggering criterion, a Redcap UE stationary not at cell edge triggering criterion, or any other triggering criteria.

If the UE 115 triggers RRM relaxation, the UE 115 may reduce a quantity of measurements performed at the UE 115 based on a periodicity of measurements, a pause of measurements, or both. In some cases, the UE 115 may apply a first relaxation method (Method 1) by lengthening a periodicity of RRM measurements. For example, the UE 115 may perform relatively fewer RRM measurements based on performing the RRM measurements according to a relatively longer interval (e.g., periodicity) in accordance with a scaling factor. In some other cases, the UE 115 may apply a second relaxation method (Method 2) by pausing—or otherwise stopping-RRM measurements for a threshold time (e.g., up to an hour). The UE 115 may trigger a specific relaxation method based on one or more triggering criteria satisfied by the UE 115, for example, in accordance with a lookup table or other configured rule. Accordingly, the UE 115 may support an improved processing overhead relating to RRM measurements, for example, by reducing a quantity of measurements performed by the UE 115.

However, in some wireless communications systems 100, a network entity 105 may similarly perform one or more power saving procedures to improve a processing overhead at the network entity 105. In some examples, a power saving procedure may involve reducing a processing overhead associated with SSB transmissions. A network entity 105 may periodically transmit an SSB (e.g., including a primary synchronization signal (PSS), a secondary synchronization signal (SSS), and a physical broadcast channel (PBCH) portion including one or more PBCH demodulation reference signals (DMRSs) and PBCH data) to support RRM measurements by UEs 115. For example, a UE 115 may receive an SSB from a network entity 105, perform one or more measurements on the SSB, and acquire synchronization (e.g., time synchronization, frequency synchronization) with a cell associated with the network entity 105 based on the SSB. The UE 115 may determine whether to switch to a different cell based on one or more of the SSB measurements.

In some systems, the network entity 105 may reduce a quantity of SSB transmissions performed by the network entity 105 to improve the processing overhead and power consumption at the network entity 105. Reduction of the quantity of SSB transmissions may be referred to as “light SSB.” In some cases, the network entity 105 may transmit relatively sparser SSBs or may transmit the SSBs in accordance with a relatively longer periodicity. Additionally, or alternatively, the network entity 105 may skip one or more SSB transmission occasions (or, in some cases, one or more SIB 1 transmission occasions). In some cases, the network entity 105 may transmit a simplified SSB including a subset of the SSB information. For example, the simplified SSB may include the PSS with no SSS or PBCH portion, the PSS and SSS with no PBCH portion, or the PSS, SSS, and a partial PBCH portion (e.g., a subset of the PBCH DMRSs, a subset of the PBCH data). Additionally, or alternatively, the network entity 105 may transmit the SSB using a reduced quantity of antenna ports, a reduced transmit power, or both based on a currently active NES at the network entity 105.

Any such changes to SSB transmissions at a network entity 105 may affect the UEs 115 performing measurements (e.g., RRM measurements, RLM measurements) of the SSBs. To support coordination between the network entity 105 and a UE 115, the network entity 105 may indicate network power saving information to the UE 115. For example, the network entity 105 may support outputting, for one or more UEs 115, an indication of an active NES for a serving cell or non-serving cell (e.g., using a communications manager 102). A UE 115 may support receiving the indication of the active NES (e.g., using a communications manager 101). Based on the active NES, the UE 115 may determine a change to SSB transmissions for the serving cell or non-serving cell and may adjust SSB monitoring accordingly. For example, the UE 115 may reduce a quantity of SSB measurements performed, may skip an SSB measurement occasion, may process a simplified SSB, may perform SSB measurements using adjusted thresholds, or any combination thereof to account for corresponding SSB transmission changes at the network entity 105 (e.g., in accordance with the currently active NES).

If the network entity 105 configures or otherwise adapts a relatively longer periodicity for SSB transmissions, the network entity 105 may support signaling to inform one or more UEs 115 (e.g., a single UE 115 or a group of UEs 115) about the configuration or adaptation. The network entity 105 may support similar signaling for changes to SIB1 transmissions, uplink RACH opportunities, or both. The signaling may improve system information (SI) acquisition, initial access, RRM measurements, RLM measurements, beam management (BM) measurements, UE performance, or any combination thereof for a UE 115 determining the updated periodicity based on the signaling.

If the network entity 105 skips one or more SSB transmission occasions, SIB1 transmission occasions, or both, the network entity 105 may support signaling to inform one or more UEs 115 (e.g., a single UE 115 or a group of UEs 115) about the skipping. The signaling may improve initial access, RRM measurements, RLM measurements, BM measurements, UE performance, or any combination thereof for a UE 115 determining the skipped SSB transmission occasions (and, correspondingly, determining which SSB measurement occasions to skip at the UE 115) based on the signaling. In some cases, the network entity 105 may perform SSB skipping for a carrier based on UE capabilities of the UEs 115 using the carrier (e.g., if the UEs 115 support skipping of SSB measurement occasions).

If the network entity 105 transmits a simplified SSB, the network entity 105 may support signaling to inform one or more UEs 115 (e.g., a single UE 115 or a group of UEs 115) that the network entity 105 is using the simplified version of the SSB. The signaling may improve SI acquisition, initial access, RRM measurements, RLM measurements, UE mobility, or any combination thereof for a UE 115 determining and processing the simplified version of the SSB based on the signaling. In some cases, the network entity 105 may perform transmission of simplified SSBs for a carrier based on UE capabilities of the UEs 115 using the carrier (e.g., if the UEs 115 support processing of simplified SSBs). Accordingly, the network entity 105, using a communications manager 102, may support signaling to coordinate network power savings and UE power savings with one or more UEs 115. A UE 115 may receive such signaling using a communications manager 101 and may perform SSB monitoring, SSB measurements, or both based on the signaling.

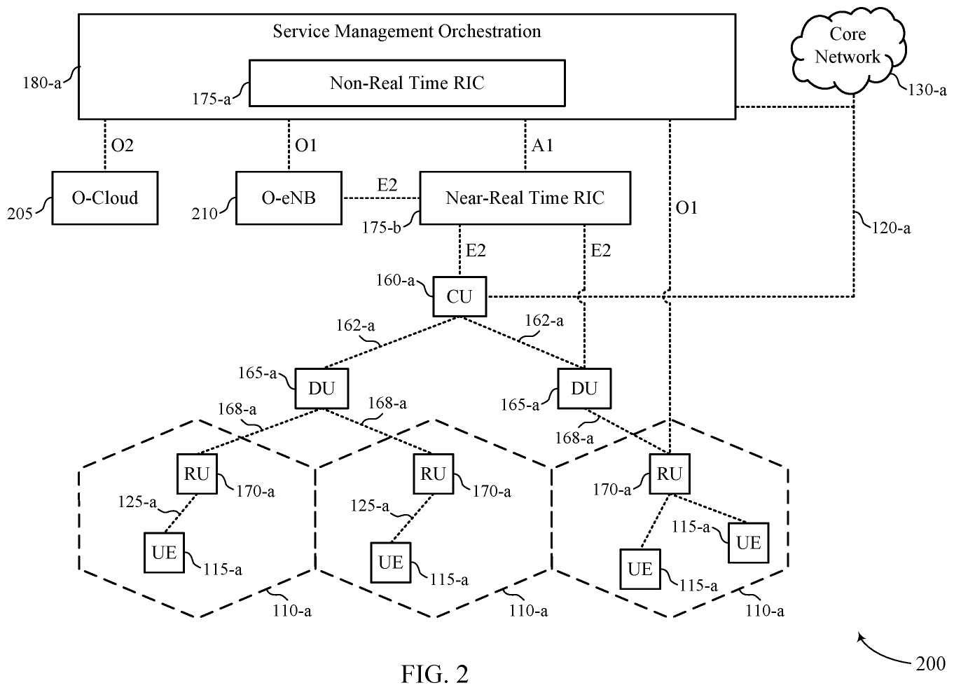

FIG. 2 illustrates an example of a network architecture 200 that supports SSB procedures based on network power savings in accordance with one or more aspects of the present disclosure. The network architecture 200 may be an example of a disaggregated base station architecture or a disaggregated RAN architecture. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

The network architecture 200 may support network power saving procedures. For example, one or more network entities 105 supporting a cell (e.g., a serving cell for a UE 115-a, a neighboring cell for a UE 115-a) may enter a network power saving mode (e.g., activate a specific NES) to improve processing overheads at the one or more network entities 105. For example, a CU 160-a, a DU 165-a, an RU 170-a, or any combination thereof may perform network power saving procedures. An RU 170-a may communicate with a UE 115-a to coordinate the network power saving information. For example, the RU 170-a may transmit, to the UE 115-a, an indication of an active NES for a cell or network entity 105 (e.g., for the RU 170-a, a DU 165-a, a CU 160-a) from a set of multiple NESs. Additionally, the RU 170-a (or a different RU 170-a corresponding to the indicated active NES) may transmit an SSB based on the active NES. In some cases, one network entity 105 of the network architecture 200 may output, and a second network entity 105 may obtain, the indication of the active NES, the SSB, or both. Additionally, or alternatively, any network entity 105 (e.g., a CU 160-a, a DU 165-a, an RU 170-a) may help facilitate communications with a UE 115-a further based on the active NES.

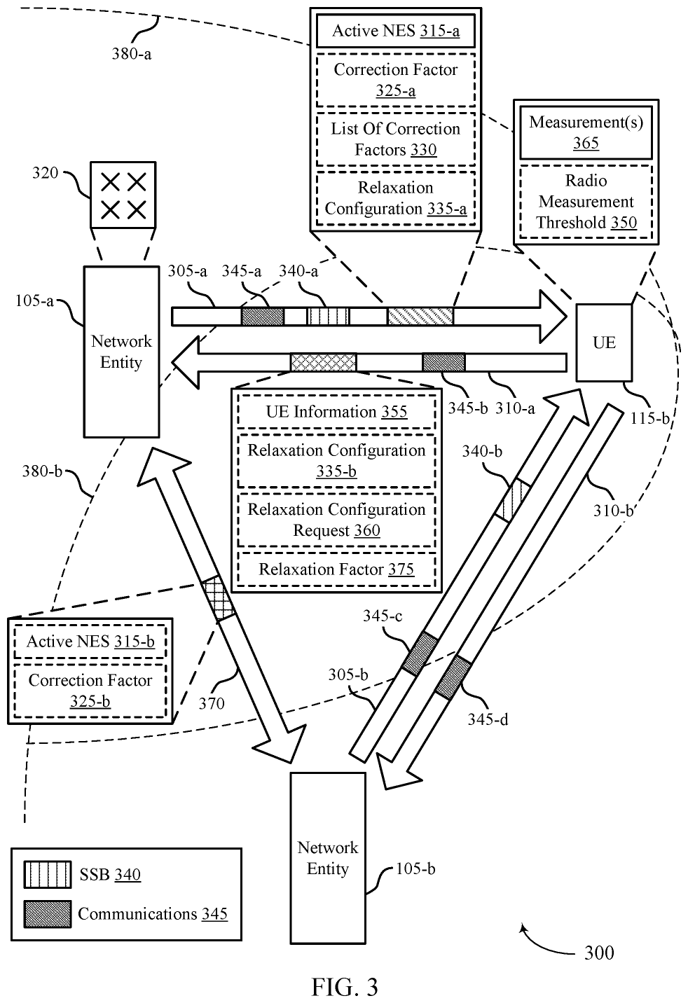

FIG. 3 illustrates an example of a wireless communications system 300 that supports SSB procedures based on network power savings in accordance with one or more aspects of the present disclosure. The wireless communications system 300 may be an example of a wireless communications system 100 as described herein with reference to FIG. 1. The wireless communications system 300 may use a network architecture 200 as described herein with reference to FIG. 2. The wireless communications system 300 may include a first network entity 105-a, a second network entity 105-b, and a UE 115-b, which may be examples of the corresponding devices described herein with reference to FIGS. 1 and 2. In some examples, the first network entity 105-a may be an example or component of a serving cell 380-a or serving network entity, and the second network entity 105-b may be an example or component of a non-serving cell 380-b (e.g., a neighboring cell 380-b) or non-serving network entity. The first network entity 105-a may communicate with the UE 115-b via a downlink channel 305-a and an uplink channel 310-a. The second network entity 105-b may communicate with the UE 115-b via a downlink channel 305-b and an uplink channel 310-b. The first network entity 105-a and the second network entity 105-b may communicate via one or more links 370 (e.g., backhaul links). The first network entity 105-a may indicate network power saving information to the UE 115-b, and the UE 115-b may determine a configuration for communication based on the indicated network power saving information (e.g., an indicated active NES 315-a).

A network entity 105 may support multiple NESs to dynamically adjust network power savings. For example, the network entity 105 may switch from a first NES to a second NES to improve a power overhead at the network entity 105. Additionally, or alternatively, the network entity 105 may switch from the second NES to the first NES to improve communication coverage, reliability, or both for a set of UEs 115 (e.g., a set of UEs 115 served by the network entity 105). In some examples, the first NES may be referred to as a “default” or “legacy” NES, and the second NES may be referred to as a “power saving” NES. The network entity 105 may support any quantity of NESs (e.g., configured at the network entity 105, configured by a core network). In some cases, a first network entity 105-a and a second network entity 105-b may support different quantities of NESs.

A NES may correspond to a specific quantity of active antenna ports (e.g., active antenna ports for transmission, active antenna ports for reception, or both) at the network entity 105, a specific transmit power for the network entity 105 (e.g., for a control or synchronization signal, such as an SSB), or both. In some cases, the network entity 105-a may enter a power saving mode. The network entity 105-a may reduce the quantity of active antenna ports, reduce a transmit power, or both to improve a processing overhead (e.g., improve power consumption) at the network entity 105-a. For example, the network entity 105-a may include an array of antenna ports 320. The network entity 105-a may deactivate one or more antenna ports of the array of antenna ports 320 based on entering the low power mode or switching to a relatively lower power NES. For example, the network entity 105-a may deactivate physical antennas, logical antenna ports, or both. The network entity 105-a may activate one or more antenna ports of the array of antenna ports 320 based on entering a full power mode (e.g., corresponding to a default NES) or switching to a relatively higher power NES.

The currently active NES 315-a for a network entity 105-a may affect transmissions of the network entity 105-a. The network entity 105-a may transmit one or more reference signals, one or more control signals, or both using the quantity of active antenna ports, the transmit power, or both corresponding to the active NES 315-a. For example, the network entity 105-a may transmit an SSB 340-a in accordance with the active NES 315-a parameters (e.g., the corresponding quantity of active antenna ports, the corresponding transmit power). A UE 115-b receiving the SSB 340-a may perform one or more measurements 365 using the SSB 340-a. The measurements 365 (e.g., RRM measurements, RLM measurements) may be affected by the active NES 315-a. For example, the UE 115-b may determine relatively lower power measurements 365, relatively lower quality measurements 365, or both based on the network entity 105-a transmitting the SSB 340 using a relatively lower power active NES 315-a.

The network entity 105-a and the UE 115-b may coordinate network power saving information to account for the currently active NES 315-a. For example, the network entity 105-a may transmit an indication of an active NES 315-a (e.g., from a set of multiple NESs supported by a network entity 105) to the UE 115-b. For example, the network entity 105-a may be an example of a serving cell 380-a transmitting an indication of an active NES 315-a for the serving cell 380-a or transmitting an indication of an active NES 315-b for a non-serving cell 380-b (e.g., corresponding to the network entity 105-b). The UE 115-b may receive the indication of the active NES (e.g., for the serving cell 380-a or the non-serving cell 380-b) and may determine one or more parameters for receiving SSBs from the serving cell 380-a or the non-serving cell 380-b based on the indicated NES. If the network changes an active NES for a cell, the network entity 105-a may transmit an indication of the updated active NES for the cell to one or more UEs 115.

In some examples, the UE 115-b may determine one or more radio measurement thresholds 350 based on an active NES. For example, the network may change one or more RRM thresholds, one or more RLM thresholds, a time duration for low mobility evaluation T_{SearchDeltaP}, or any combination thereof based on the active NES (e.g., the power saving mode at the network). The UE 115-b may determine the one or more changed thresholds (e.g., an adaptation to a threshold, a correction to a threshold, a different threshold value) based on the indication of the active NES. In some examples, the UE 115-b may determine a correction factor 325-a for a radio measurement threshold 350 (e.g., an RSRP threshold, an RSRQ threshold) based on the indicated active NES 315-a. The correction factor 325-a may be an absolute correction (e.g., a value to set the threshold to) or may be a delta correction relative to a default power state. For example, the UE 115-b may be configured with a default value for a radio measurement threshold 350. In some cases, the default value may correspond to NES1 (e.g., a non-power saving NES). The UE 115-b may determine an active NES (e.g., different from NES1, the default NES) and may update the default value for the radio measurement threshold 350 based on the correction factor 325-a corresponding to the active NES. The UE 115-b may increase or decrease the default value by adding the correction factor 325-a to the default value, subtracting the correction factor 325-a from the default value, multiplying the correction factor 325-a by the default value, or setting the value of the radio measurement threshold 350 to the correction factor 325-a value.

Additionally, or alternatively, the UE 115-b may adjust one or more measurements 365 performed based on the indicated active NES 315-a. For example, the UE 115-b may apply a correction factor 325-a to a radio resource measurement performed on an SSB 340. The UE 115-b may compare the adjusted measurement 365 to a default radio measurement threshold 350. In some examples, the UE 115-b may adjust the one or more measurements 365, adjust one or more radio measurement thresholds 350, or both based on the active NES 315-a (e.g., using one or more correction factors).

The network entity 105-a may transmit a signal configuring one or more correction factors for the UE 115-b. In some examples, the network entity 105-a may use L1 signaling, L2 signaling, L3 signaling, or some combination thereof to indicate the correction factors. In some cases, the network entity 105-a may indicate associations between NESs (e.g., power saving states) and correction factors. In such cases, the UE 115-b may determine one or more respective correction factors to use based on the indicated active NES 315-a. In some other cases, the network entity 105-a may indicate, with the indicated active NES 315-a, an indication of one or more corresponding correction factors. In yet some other cases, the network entity 105-a may indicate the relevant one or more correction factors for the UE 115-b to use, and the indicated one or more correction factors may implicitly indicate the currently active NES.

In some examples, the network entity 105-a may configure one or more lists of correction factors 330 for one or more UEs 115. For example, the network entity 105-a may configure the lists of correction factors 330 via L3 signaling, such as an RRC signal, a MIB, a SIB (e.g., SIB1 or other SIB), a RACH message, or some other signaling. A list of correction factors 330 may include multiple correction factors. The network entity 105-a may indicate a specific correction factor 325-a for the UE 115-b to use from a configured list of correction factors 330 for a NES (e.g., for each configured NES). For example, the network entity 105-a may dynamically indicate the correction factor 325-a from the list via L1 signaling or L2 signaling, such as a DCI signal, a MAC-CE, or some other signaling. The network entity 105-a may configure different list sizes for different UEs 115, different NESs, or both. For example, the network entity 105-a may configure the UE 115-b with a first list of correction factors 330 of a first size (e.g., with a first quantity of configured values) for a first NES, configure the UE 115-b with a second list of correction factors 330 of a second size for a second NES, configure a different UE 115 with a third list of correction factors 330 of a third size for the first NES, or any combination thereof. The network entity 105-a may configure relatively larger list sizes to support relatively more dynamic configurations (e.g., more options for selecting a correction factor 325-a). The network entity 105-a may configure relatively smaller list sizes to support relatively lower signaling overheads (e.g., for configuring a list, for indicating a value within the list).

As an example, the network entity 105-a may configure the UE 115-b with a first radio measurement threshold 350 S_{searchThresholdP1} for RSRP and a second radio measurement threshold 350 S_{searchThresholdQ1} for RSRQ. If a cell (e.g., a serving cell 380-a or non-serving cell 380-b) is operating with a first NES, NES1, the UE 115-b may use the configured thresholds S_{searchThresholdP1} and S_{searchThresholdQ1} for measurements (e.g., SSB measurements). For example, the UE 115-b may connect to a cell if a measured RSRP for an SSB 340 satisfies the S_{searchThresholdP1}, if a measured RSRQ for the SSB 340 satisfies the S_{searchThresholdQ1}, or both.

The network entity 105-a may additionally configure the UE 115-b with delta values (e.g., correction factors) for the one or more configured thresholds for one or more additional NESs. For example, the network entity 105-a may configure correction factors X1, X2, Y1, Y2, Z1, and Z2 for NES2, NES3, and NES4. Table 1 illustrates how the UE 115-b may determine threshold values for different active NESs using the configured thresholds and the configured correction factors.

TABLE 1
Example determination of radio measurement thresholds

| Network Energy State | UE Threshold Values |
|---|---|
| NES1 | S_{SearchThresholdP1} |
| | S_{SearchThresholdQ1} |
| NES2 | S_{SearchThresholdP1} + X1 |
| | S_{SearchThresholdQ1} + X2 |
| NES3 | S_{SearchThresholdP1} + Y1 |
| | S_{SearchThresholdQ1} + Y2 |
| NES4 | S_{SearchThresholdP1} + Z1 |
| | S_{SearchThresholdQ1} + Z2 |

In some cases, rather than configure a single value for a correction factor (e.g., X1 or another correction factor), the network entity 105-a may configure a list of correction factors 330 for X1 and may indicate the specific value from the list for the UE 115-b to use for X1.

In some examples, cells may communicate (e.g., gNB to gNB) power state information, correction factor information, or both to coordinate between the cells. Additionally, or alternatively, a core network entity or core network function may coordinate power state information, correction factor information, or both across multiple cells (e.g., across network entities 105). The network entity 105-a may be associated with the serving cell 380-a for the UE 115-b. The network entity 105-b may be associated with a non-serving cell 380-b (e.g., a neighbor cell 380-b) for the UE 115-b. The network entity 105-b may output, to the network entity 105-a via a link 370 (e.g., an Xn interface, an X2 interface), at least one power saving state (e.g., the active NES 315-b for the non-serving cell 380-b), one or more correction factors 325-b, one or more thresholds or configurations for RRM measurements, or any combination thereof for the non-serving cell 380-b. The serving cell 380-a for the UE 115-b may provide the power state information, the correction factor information, or both for one or more other cells (e.g., neighbor cells) to the UE 115-b. For example, the network entity 105-a may transmit, to the UE 115-b, an indication of the active NES 315-b, the correction factor 325-b, or both for the network entity 105-b (e.g., associated with the non-serving cell 380-b). Accordingly, the UE 115-b may adjust RRM measurements (e.g., measurements 365), thresholds (e.g., radio measurement thresholds 350, such as a time duration for low mobility, T_{SearchDeltaP}), or any combination thereof for receiving signals (e.g., SSBs) from one or more other cells. For example, the UE 115-b may use the indicated active NES 315-b to monitor for and measure an SSB 340-b from the network entity 105-b (e.g., associated with the non-serving cell 380-b). The UE 115-b may communicate with the network entity 105-b based on the measurements of the SSB 340-b (e.g., via communications 345). For example, the UE 115-b may receive one or more downlink communications 345-c, transmit one or more uplink communications 345-d, or both.

In some examples, the UE 115-b may determine a relaxation configuration 335-a for a cell (e.g., a serving cell 380-a, a non-serving cell 380-b) based on an indicated active NES. The relaxation configuration 335-a may indicate, to the UE 115-b, occasions to monitor for SSBs 340, occasions to skip monitoring for SSBs 340, or both. In some cases, the network entity 105-a may transmit a signal configuring relaxation configurations (or no relaxation) for corresponding NESs. The signaling may be L1 signaling, L2 signaling, L3 signaling, or some other signaling. The UE 115-b may monitor for SSBs 340 based on the relaxation configuration 335-a corresponding to the indicated active NES 315-a.

In some examples, the UE 115-b may refrain from measuring an SSB 340 based on the relaxation configuration 335-a. Additionally, or alternatively, the UE 115-b may discard one or more measurements 365 for the SSB 340 based on the relaxation configuration 335-a, a radio measurement threshold 350, or both. For example, the UE 115-b may measure a received SSB 340 and may compare a measurement 365 of the SSB 340 to an adjusted radio measurement threshold 350. Based on the comparison, the UE 115-b may determine to discard the measurement 365 (e.g., the UE 115-b may operate as if the UE 115-b skipped the measurement 365). In some cases, the UE 115-b may determine to discard, relax, skip, or cancel one or more measurement occasions based on a configuration of a relaxation configuration 335-a, a configuration of a radio measurement threshold 350 for the UE 115-b, or both. For example, the UE 115-b may refrain from performing measurements (e.g., the UE 115-b may not perform measurements, skip performing measurements, cancel measurement occasions, enter a relatively low power mode, or any combination thereof) based on a configured radio measurement threshold 350, or the UE 115-b may perform the measurements but may refrain from storing the measurements based on the configured radio measurement threshold 350.

In some cases, one or more UEs 115 may indicate information to the network (e.g., a network entity 105, such as a base station, a core network entity, or any other network entity 105), and the network may use the UE information to select an active NES, determine a correction factor, determine a relaxation configuration, or any combination thereof. For example, the UE 115-b may transmit UE information 355 to the network entity 105-a (e.g., via L1, L2, or L3 signaling), a core network entity (e.g., via L1, L2, or L3 upper layer protocols), or both. In some cases, the network entity 105-a may be an example or component of a core network entity. The UE 115-b may transmit a UE capability report or other UCI signaling indicating the UE information 355. The UE information 355 may include one or more UE capabilities, a UE type, a power state for the UE, a power saving mode of the UE, a sleeping mode of the UE, a mobility prediction for the UE, or any combination thereof. Based on the obtained UE information 355, the network entity 105-a or a core network entity may determine—or otherwise select-a configuration (e.g., a correction factor 325-a, a relaxation configuration 335-a) for the active NES 315-a. The network entity 105-a may indicate the determined configuration for the active NES 315-a to the UE 115-b. In some cases, the network entity 105-a or the core network entity may determine the configuration for the active NES 315-a based on UE information obtained from multiple UEs 115. Additionally, or alternatively, multiple cells may coordinate information such that the network (e.g., at the core network) may determine configurations for active NESs of non-serving cells.

In some examples, the UE 115-b may indicate whether it supports relaxation configurations 335-b (e.g., a relaxation mode, one or more specific relaxation configurations) to the network entity 105-a or a core network entity (e.g., via one or more upper layer protocols), and the network entity 105-a or the core network entity may determine an active NES 315-a or a configuration (e.g., a correction factor 325-a, a relaxation configuration 335-a) for the active NES 315-a based on the indicated UE relaxation support. Additionally, or alternatively, the UE 115-b may indicate a currently active UE relaxation configuration 335-b at the UE 115-b (e.g., a relaxed measurement configuration) to the network entity 105-a or the core network entity. For example, multiple UEs 115 may indicate, to the network entity 105-a or the core network entity, that the UEs 115 are stationary. In response, the network entity 105-a or the core network entity may determine a relaxation configuration 335-a for these stationary UEs 115 for a time period (e.g., an hour) or based on a scaling factor. In some cases, the network may trigger a network power saving mode, select a specific SSB configuration, select a specific RRM measurement setting, or any combination thereof for a cell based on the indicated relaxation configurations 335-b for one or more UEs 115 served by the cell.

Additionally, or alternatively, the UE 115-b may transmit a relaxation configuration request 360 to the network entity 105-a or a core network entity. For example, the UE 115-b may determine a relaxation configuration based on mobility of the UE 115-b, a power saving mode of the UE 115-b, a power state of the UE 115-b, a sleeping mode of the UE 115-b, an RRC state of the UE 115-b, or any other UE information 355. The UE 115-b may transmit the request for the determined relaxation configuration (e.g., a request for an RRM relaxation configuration) via L1 signaling, L2 signaling, L3 signaling, or any other signaling (e.g., in user assistance information, a dedicated physical uplink control channel (PUCCH) signal, a dedicated physical uplink shared channel (PUSCH) signal, an RRC signal, a MAC-CE). In some examples, the UE 115-b may send the determined relaxation configuration to the core network via an L1 upper layer protocol, an L2 upper layer protocol, an L3 upper layer protocol, or some combination thereof. Additionally, or alternatively, the UE 115-b may transmit a request for a specific relaxation factor 375 (e.g., an RRM relaxation factor) to the network entity 105-a (e.g., with the relaxation configuration request 360 or instead of the relaxation configuration request 360) or the core network entity. In some examples, the UE 115-b may multiplex the relaxation configuration request 360 with L1 signaling, L2 signaling, L3 signaling, or any other signaling (e.g., a scheduling request (SR), a buffer status report (BSR), a HARQ-ACK message, a power headroom (PHR) signal, channel state information (CSI), a RACH message, a PUSCH message). Based on the relaxation configuration request 360, the network entity 105-a or the core network may determine a relaxation configuration 335-a for the UE 115-b (e.g., corresponding to the active NES 315-a). The network entity 105-a or the core network may select the requested configuration or may select a different configuration based on the request.

In some examples, the network entity 105-a, the network entity 105-b, or both may communicate with the core network to support the network power savings. For example, the network entity 105-a, the network entity 105-b, or both may send configuration information for one or more network entities 105, one or more UEs 115, or both to the core network, and the core network (e.g., using a core network function) may determine NES information, threshold information, configuration information (e.g., for a relaxation configuration), or any combination thereof based on the received configuration information. In some cases, the core network may communicate the NES information, threshold information, configuration information, or combination thereof with one or more network entities 105. For example, the core network may send, to one or more network entities 105, configuration or relaxation information for UEs 115 (e.g., for the UE 115-b) for different RRC or NES states. Additionally, or alternatively, the core network may support one or more upper layer protocols dedicated for communication (e.g., with network entities 105, with UEs 115) of information relating to network power savings, such as active NES information, correction factor information, relaxation configuration information, UE information 355, relaxation configuration requests 360, relaxation factors 375, or any combination thereof. According to one or more examples, the core network may perform one or more operations described herein with reference to the network entity 105-a, the network entity 105-b, or both.

The UE 115-b may receive an SSB 340-a from the network entity 105-a based on the active NES 315-a and may perform one or more measurements 365 based on the active NES 315-a. The UE 115-b may communicate with the network entity 105-a based on the measurements of the SSB 340-a (e.g., via communications 345). For example, the UE 115-b may receive one or more downlink communications 345-a, transmit one or more uplink communications 345-b, or both.

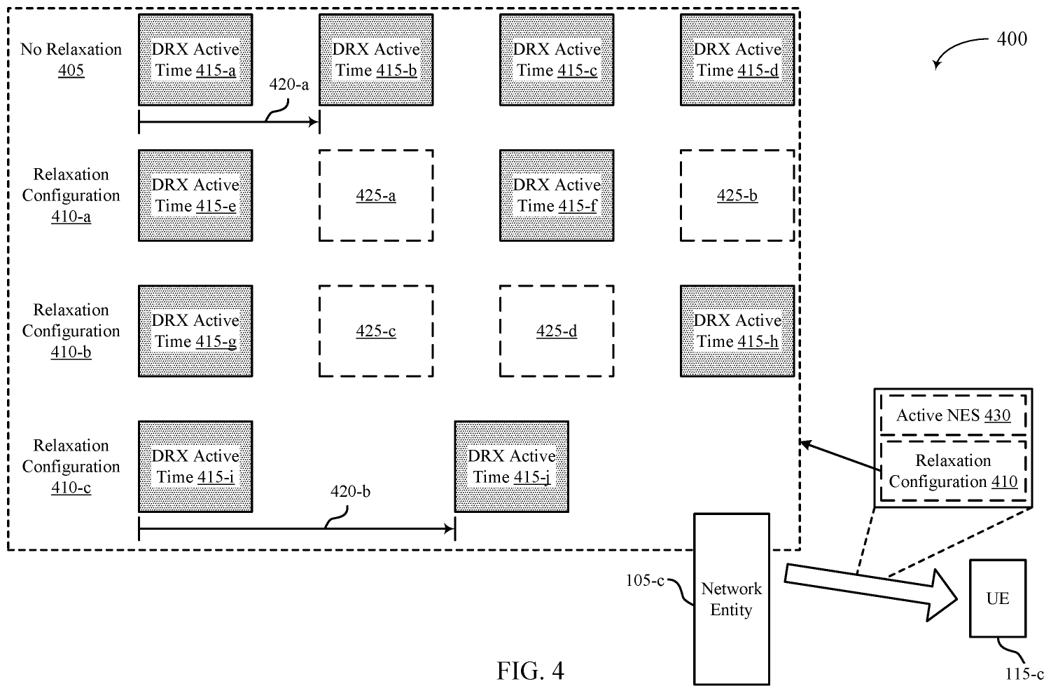

FIG. 4 illustrates an example of relaxation configurations 400 that support SSB procedures based on network power savings in accordance with one or more aspects of the present disclosure. A network entity 105-c and a UE 115-c, which may be examples of devices described herein with reference to FIGS. 1 through 3, may coordinate relaxation configurations 400. The network entity 105-c may configure a set of discontinuous reception (DRX) active times for a UE 115-c, for example, based on a first periodicity 420-a. The set of DRX active times may correspond to no relaxation 405 at the network. For example, if a network entity operates according to a first NES associated with the no relaxation 405 (e.g., a “default” NES, such as a NES associated with no, or negligible, power saving procedures at the network), the network entity may transmit an SSB during each configured DRX active time. During a DRX active time, the network entity 105-c may transmit an SSB, and the UE 115-c may monitor for and receive the SSB and perform one or more RRM measurements using the received SSB. However, in some examples, the network entity 105-c may switch to a different active NES 430, which may correspond to a different relaxation configuration 410. For a relaxation configuration 410, the network entity 105 may reduce a quantity of SSBs transmitted for reception by UEs 115. To improve coordination between the network entity 105-c and the UEs 115-c, the network entity 105 may indicate the current relaxation configuration 410 to the UEs 115.

In some cases, the network entity 105-c may transmit an indication of an active NES 430 that corresponds to a specific relaxation configuration 410. For example, the network entity 105-c (e.g., a serving cell) may configure a relaxation configuration 410 (e.g., an RRM relaxation procedure) for the UE 115-c per NES. In some other cases, the network entity 105-c may transmit an indication of the active relaxation configuration 410 (e.g., based on the active NES 430 at the network entity 105-c). The network entity 105-c may transmit an indication of a relaxation configuration 410 for a serving cell, one or more respective relaxation configurations 410 for one or more non-serving cells, or both. The UE 115-c may modify configured DRX active times based on the one or more indicated relaxation configurations.

In some examples, the network entity 105-c may support multiple RRM relaxation configurations, where each RRM relaxation configuration may indicate a configuration-specific periodicity length, skipping periodicity, or both. Additionally, or alternatively, an RRM relaxation configuration may indicate one or more threshold changes (e.g., delta values or threshold values for an RSRP threshold, an RSRQ threshold, or another threshold). In some other examples, the network entity 105-c may support a single RRM relaxation configuration that supports multiple RRM measurement relaxation factors. For example, an RRM measurement relaxation factor may define—or otherwise indicate-a periodicity length, a skipping periodicity, or both. Additionally, or alternatively, the RRM measurement relaxation factor may indicate one or more threshold changes.

Network entities 105 may coordinate NES information, relaxation configuration information, or both via one or more interfaces (e.g., Xn or X2 interfaces). For example, neighboring cells may output, to other cells via backhaul interfaces, active NES information, such that a serving cell may store active NES information (e.g., including corresponding relaxation configuration information) for neighboring cells. The serving cell may determine SSB transmission configurations for one or more neighboring cells. The serving cell may transmit an indication of a relaxation configuration 410, an indication to skip one or more RRM measurement occasions, an indication of an RRM measurement periodicity, or any combination thereof (e.g., for the serving cell or for a non-serving cell) to a UE 115. For example, the serving cell may transmit the indication via an L1 signal (e.g., a DCI signal), an L2 signal (e.g., a MAC-CE), or an L3 signal (e.g., an RRC signal, a MIB, a SIB, a RACH message).

In some examples, the network entity 105-c may configure one or more lists of relaxation factors, RRM measurement configurations, or both via first signaling (e.g., RRC signaling, a MAC-CE). The network entity 105-c may indicate an active relaxation factor, RRM measurement configuration, or both from the lists for a UE 115-c to use via second signaling (e.g., a MAC-CE, DCI signaling) based on a currently active NES.

If configured with no relaxation 405, the UE 115-c may monitor for SSBs in a first DRX active time 415-a, a second DRX active time 415-b, a third DRX active time 415-c, and a fourth DRX active time 415-d in accordance with a first periodicity 420-a. A relaxation configuration 410 may involve skipping of one or more DRX active times, a modified periodicity, or both. For example, a first relaxation configuration 410-a (e.g., corresponding to a first NES) may involve a first DRX active time 415-e, a skipped DRX occasion 425-a, a second DRX active time 415-f, and another skipped DRX occasion 425-b. That is, a network entity 105-c may conserve power by reducing the quantity of SSBs transmitted (e.g., refraining from transmitting every other SSB). The UE 115-c may use the corresponding first relaxation configuration 410-a to monitor during DRX active times in which the network entity 105-c transmits an SSB and to refrain from monitoring during skipped DRX occasions in which the network entity 105-c similarly refrains from transmitting an SSB.

A second relaxation configuration 410-b (e.g., corresponding to a second NES) may involve a first DRX active time 415-g, a skipped DRX occasion 425-c, another skipped DRX occasion 425-d, and a second DRX active time 415-h. The second relaxation configuration 410-b may involve relatively more skipped occasions than the first relaxation configuration 410-a (e.g., based on the second relaxation configuration 410-b corresponding to a relatively lower energy NES, or, correspondingly, relatively greater network power savings, than the first relaxation configuration 410-a). A third relaxation configuration 410-c (e.g., corresponding to a third NES) may involve a modified periodicity (e.g., a second periodicity 420-b that is relatively longer than the periodicity 420-a for no relaxation 405). The third relaxation configuration 410-c may involve a first DRX active time 415-i and a second DRX active time 415-j in accordance with the second periodicity 420-b. The network entity 105-c may transmit SSBs in accordance with the second periodicity 420-b, and the UE 115-c may monitor for SSBs in accordance with the second periodicity 420-b.

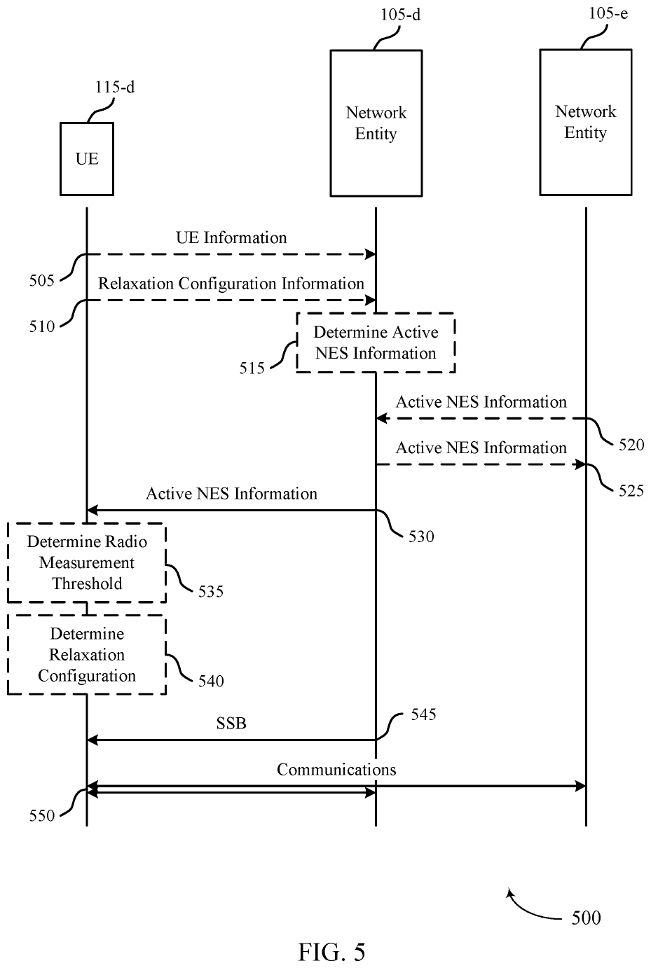

FIG. 5 illustrates an example of a process flow 500 that supports SSB procedures based on network power savings in accordance with one or more aspects of the present disclosure. In some examples, the process flow 500 may be implemented by aspects of the wireless communications system 100, the network architecture 200, the wireless communications system 300, or any combination thereof. For example, the process flow 500 may include a UE 115-d, a network entity 105-d (e.g., associated with a serving cell for the UE 115-d), and a network entity 105-e (e.g., associated with a non-serving cell for the UE 115-d), which may be examples of a UE 115 and network entities 105 as described with reference to FIGS. 1 through 4. The network entity 105-d, the network entity 105-e, or both may be examples of CUs, DUs, RUs, core network entities, or any combination thereof. In the following description of the process flow 500, the operations between the devices may be performed in different orders or at different times. Some operations may be left out of the process flow 500, or other operations may be added. Although the UE 115-d, the network entity 105-d, and the network entity 105-e are shown performing the operations of the process flow 500, some aspects of some operations may be performed by one or more other devices.

In some examples, at 505, the UE 115-d may transmit, for the network entity 105-d (e.g., associated with a serving cell), UE information for the UE 115-d. The UE information may include a UE capability, a UE type, UE mobility information, a UE power state, a power saving mode, a sleep mode, an RRC state, or a combination thereof.

In some examples, at 510, the UE 115-d may transmit, for the network entity 105-d, relaxation configuration information. In some cases, the relaxation configuration information may indicate a relaxed measurement configuration of the UE 115-d (e.g., indicating that the UE is stationary, indicating that the UE is not near a cell edge). In some other cases, the relaxation configuration information may include a request for an RRM relaxation configuration, an RRM relaxation factor, or both for the network entity 105-d. For example, the UE 115-d may request that the network entity 105-d select a specific relaxation configuration for an active NES.

In some cases, at 515, the network entity 105-d may determine active NES information. In some examples, the network entity 105-d may determine the active NES information based on the UE information obtained at 505, the relaxation configuration information obtained at 510, or both. Determining the active NES information may involve the network entity 105-d selecting a NES to activate. Additionally, or alternatively, determining the active NES information may involve selecting a configuration corresponding to the active NES. The configuration may include a radio measurement threshold that corresponds to the active NES, a correction factor for a radio measurement threshold that corresponds to the active NES, a relaxation configuration (e.g., an RRM relaxation configuration, an RLM relaxation configuration) that corresponds to the active NES, a periodicity for SSBs that corresponds to the active NES, a skipping pattern for the SSBs that corresponds to the active NES, a first set of SSB occasions to skip for the active NES, a second set of SSB occasions to monitor for the active NES, or any combination thereof.

In some examples, multiple cells may coordinate active NES information, such that a serving cell may provide network power saving information for one or more non-serving cells (e.g., neighbor cells). For example, at 520, the network entity 105-e may output, and the network entity 105-d may obtain, a second active NES for the network entity 105-e, a correction factor for a radio measurement threshold that corresponds to the second active NES for the network entity 105-e, or both. Similarly, at 525, the network entity 105-d may output, and the network entity 105-e may obtain, the active NES for the network entity 105-d, a correction factor for a radio measurement threshold that corresponds to the active NES for the network entity 105-d, or both.

At 530, the network entity 105-d may output an indication of an active NES for a network entity (e.g., the network entity 105-d corresponding to the serving cell, the network entity 105-e corresponding to a non-serving cell) from a set of multiple NESs supported by the network. The network entity 105-d may output the indication to a specific UE (e.g., the UE 115-d) or may output the indication to multiple UEs (e.g., via broadcast, multicast, or unicast signaling) served by the network entity 105-d. The UE 115-d may receive the indication of the active NES.

In some examples, at 535, the UE 115-d may determine one or more radio measurement thresholds based on the indicated active NES. For example, the UE 115-d may determine (e.g., receive) a correction factor that corresponds to the active NES. The UE 115-d may determine a radio measurement threshold using the correction factor, for example, by setting the radio measurement threshold to a value of the correction factor or by modifying the radio measurement threshold by the value of the correction factor (e.g., adding the correction factor as a delta value).

In some examples, at 540, the UE 115-d may determine a relaxation configuration based on the indicated active NES. For example, the UE 115-d may determine (e.g., receive) an RRM relaxation configuration, an RRM relaxation factor, or both based on the indicated active NES. The UE 115-d may determine a periodicity for SSBs, a skipping pattern for the SSBs, a first set of SSB occasions to skip, a second set of SSB occasions to receive, or a combination thereof based on the relaxation configuration.

At 545, the network entity 105-d may output an SSB based on the active NES. The network entity 105-d may output the SSB in accordance with the relaxation configuration. Additionally, or alternatively, the network entity 105-d may output the SSB using a quantity of antenna ports, a transmit power, or both corresponding to the active NES. The UE 115-d may receive the SSB based on the active NES. For example, the UE 115-d may perform one or more measurements of the SSB using the determined one or more radio measurement thresholds. In some cases, the UE 115-d may receive an SSB from a non-serving cell (e.g., the network entity 105-e) based on an active NES for the non-serving cell.

At 550, the UE 115-d may communicate based on one or more measurements of one or more SSBs. In some cases, the UE 115-d may communicate with the network entity 105-d based on an SSB from the network entity 105-d (e.g., in accordance with the active NES of the network entity 105-d). In some other cases, the UE 115-d may communicate with the network entity 105-e based on an SSB from the network entity 105-e (e.g., in accordance with the active NES of the network entity 105-e).

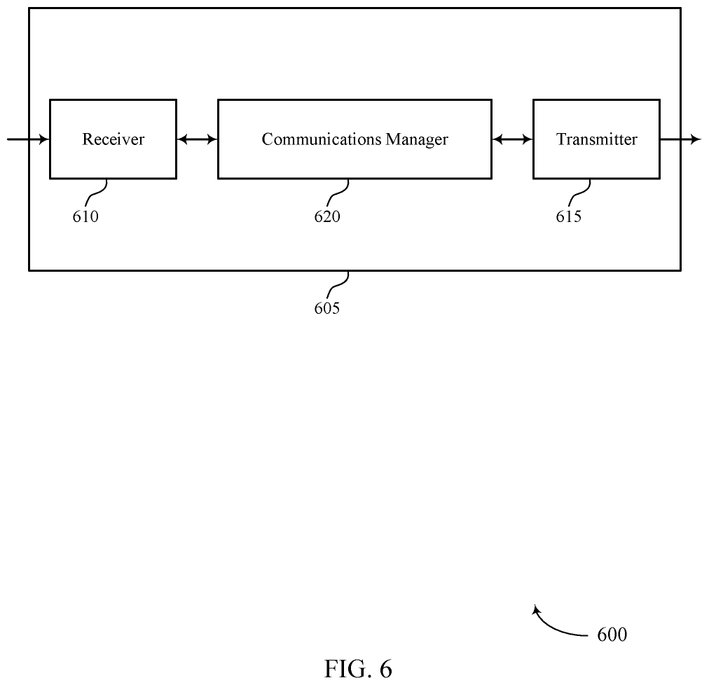

FIG. 6 illustrates a block diagram 600 of a device 605 that supports SSB procedures based on network power savings in accordance with one or more aspects of the present disclosure. The device 605 may be an example of aspects of a UE 115 as described herein. The device 605 may include a receiver 610, a transmitter 615, and a communications manager 620, which may be an example of a communications manager 101 as described herein. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to SSB procedures based on network power savings). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SSB procedures based on network power savings). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of SSB procedures based on network power savings as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving, for a network entity, an indication of an active NES from a set of multiple NESs. The communications manager 620 may be configured as or otherwise support a means for receiving an SSB for the network entity based on the active NES. The communications manager 620 may be configured as or otherwise support a means for communicating based on one or more measurements associated with the SSB.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for an improved processing overhead, an improved power consumption, more efficient utilization of communication resources, or any combination thereof for the device 605. For example, the device 605 may determine an RRM relaxation configuration corresponding to the indicated active NES and may receive the SSB according to the RRM relaxation configuration. The device 605 may refrain from monitoring for an SSB during a skipped SSB transmission occasion, reduce monitoring occasions based on an extended periodicity for SSB transmission occasions, reduce processing resources used for processing an SSB based on a simplified version of the SSB, or any combination thereof based on the relaxation configuration. Additionally, or alternatively, the device 605 may improve measurement accuracy based on determining when to measure for SSBs according to the active NES. Improved measurement accuracy may reduce the likelihood that the device 605 performs an unnecessary cell switch or acquisition procedure, further improving the processing overhead at the device 605.

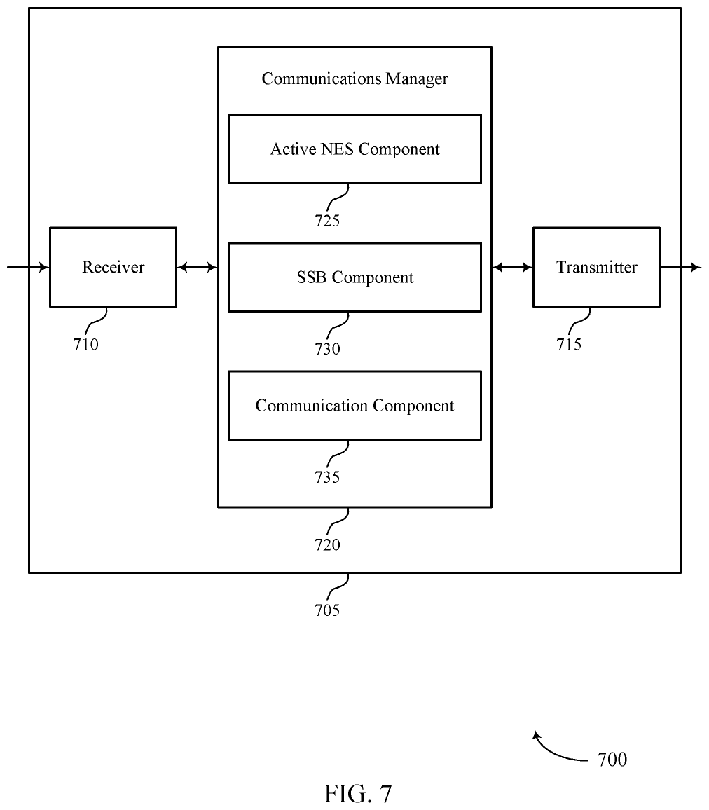

FIG. 7 illustrates a block diagram 700 of a device 705 that supports SSB procedures based on network power savings in accordance with one or more aspects of the present disclosure. The device 705 may be an example of aspects of a device 605 or a UE 115 as described herein. The device 705 may include a receiver 710, a transmitter 715, and a communications manager 720, such as a communications manager 101 as described herein. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to SSB procedures based on network power savings). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SSB procedures based on network power savings). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of SSB procedures based on network power savings as described herein. For example, the communications manager 720 may include an active NES component 725, an SSB component 730, a communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The active NES component 725 may be configured as or otherwise support a means for receiving, for a network entity, an indication of an active NES from a set of multiple NESs. The SSB component 730 may be configured as or otherwise support a means for receiving an SSB for the network entity based on the active NES. The communication component 735 may be configured as or otherwise support a means for communicating based on one or more measurements associated with the SSB.

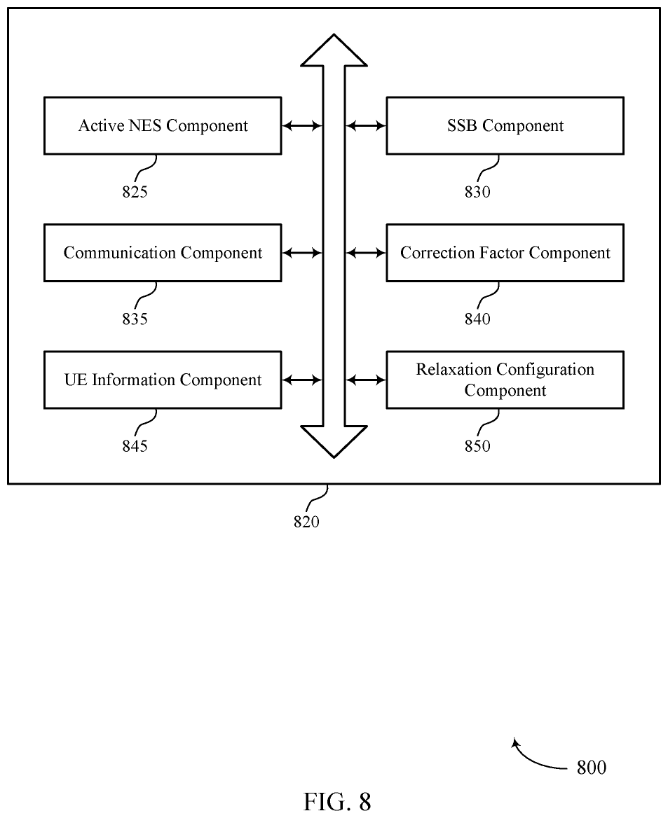

FIG. 8 illustrates a block diagram 800 of a communications manager 820 that supports SSB procedures based on network power savings in accordance with one or more aspects of the present disclosure. The communications manager 820 may be an example of aspects of a communications manager 101, a communications manager 620, a communications manager 720, or some combination thereof, as described herein. The communications manager 820, or various components thereof, may be an example of means for performing various aspects of SSB procedures based on network power savings as described herein. For example, the communications manager 820 may include an active NES component 825, an SSB component 830, a communication component 835, a correction factor component 840, a UE information component 845, a relaxation configuration component 850, or any combination thereof. Each of these components may communicate, directly or indirectly, with one another (e.g., via one or more buses).

The communications manager 820 may support wireless communications at a UE in accordance with examples as disclosed herein. The active NES component 825 may be configured as or otherwise support a means for receiving, for a network entity, an indication of an active NES from a set of multiple NESs. The SSB component 830 may be configured as or otherwise support a means for receiving an SSB for the network entity based on the active NES. The communication component 835 may be configured as or otherwise support a means for communicating based on one or more measurements associated with the SSB.

In some examples, the correction factor component 840 may be configured as or otherwise support a means for receiving a second indication of a correction factor that corresponds to the active NES. In some examples, the correction factor component 840 may be configured as or otherwise support a means for determining a radio measurement threshold based on the correction factor, the communication further based on the radio measurement threshold. In some examples, to determine the radio measurement threshold, the correction factor component 840 may be configured as or otherwise support a means for setting the radio measurement threshold to a value of the correction factor. In some other examples, to determine the radio measurement threshold, the correction factor component 840 may be configured as or otherwise support a means for modifying the radio measurement threshold in accordance with the value of the correction factor.

In some examples, the correction factor component 840 may be configured as or otherwise support a means for receiving a first signal that indicates a list of correction factors. In some examples, the correction factor component 840 may be configured as or otherwise support a means for receiving a second signal that includes the second indication of the correction factor from the list of correction factors. In some examples, the first signal includes an RRC signal, a MIB, a SIB, a RACH signal, or a combination thereof. In some examples, the second signal includes a MAC-CE, a DCI signal, or both.

In some examples, the radio measurement threshold includes an RSRP threshold, an RSRQ threshold, or both.

In some examples, to receive the SSB, the SSB component 830 may be configured as or otherwise support a means for receiving the SSB based on a periodicity for SSBs, a skipping pattern for the SSBs, a first set of SSB occasions to skip, a second set of SSB occasions to receive, or a combination thereof that corresponds to the active NES. In some examples, the relaxation configuration component 850 may be configured as or otherwise support a means for determining an RRM relaxation configuration, an RRM relaxation factor, or both based on the active NES. In some examples, the periodicity for SSBs, the skipping pattern for the SSBs, the first set of SSB occasions to skip, the second set of SSB occasions to receive, or the combination thereof may be based on the RRM relaxation configuration, the RRM relaxation factor, or both.

In some examples, the UE information component 845 may be configured as or otherwise support a means for transmitting UE information for the UE. In some examples, the active NES, a radio measurement configuration for the network entity, or both may be based on the UE information. In some examples, the UE information includes a UE capability, a UE type, UE mobility information, a UE power state, a power saving mode, a sleep mode, an RRC state, or a combination thereof.

In some examples, the relaxation configuration component 850 may be configured as or otherwise support a means for transmitting a second indication of a relaxed measurement configuration for the UE. In some examples, the active NES, a radio measurement configuration for the network entity, or both may be based on the relaxed measurement configuration for the UE.

In some examples, the relaxation configuration component 850 may be configured as or otherwise support a means for transmitting a request for an RRM relaxation configuration, an RRM relaxation factor, or both for the network entity. In some examples, the active NES, a radio measurement configuration for the network entity, or both may be based on the request.

In some examples, the active NES indicates a quantity of active antennas, a transmit power, or both for the network entity. In some examples, the network entity includes a serving network entity. In some other examples, the network entity includes a non-serving network entity, where the indication of the active NES for the non-serving network entity is received from a serving network entity.

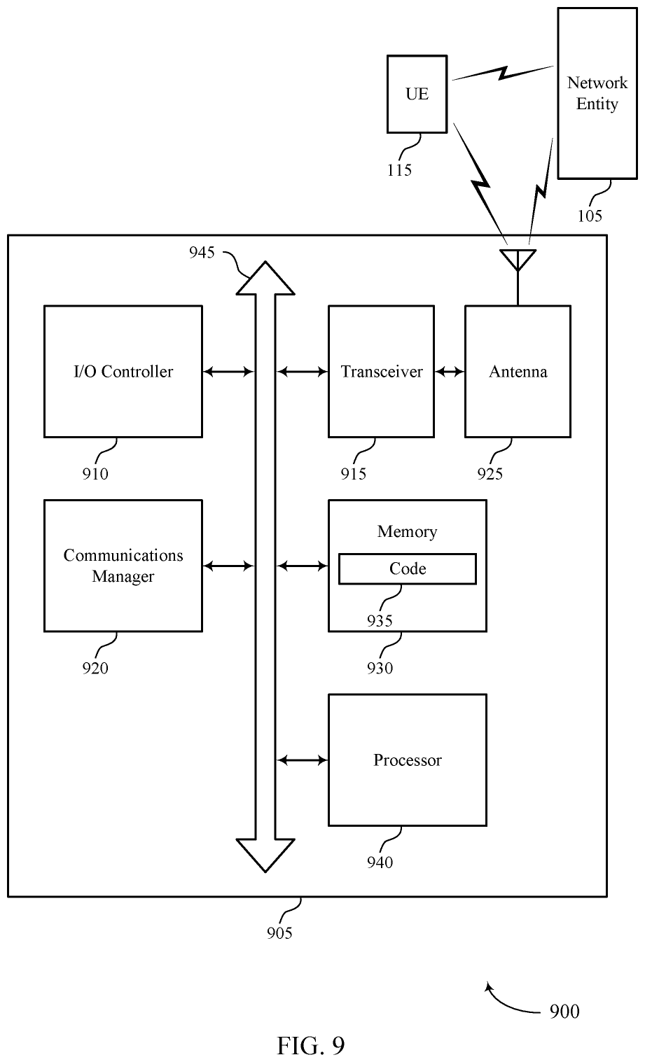

FIG. 9 illustrates a diagram of a system 900 including a device 905 that supports SSB procedures based on network power savings in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting SSB procedures based on network power savings). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, for a network entity, an indication of an active NES from a set of multiple NESs. The communications manager 920 may be configured as or otherwise support a means for receiving an SSB for the network entity based on the active NES. The communications manager 920 may be configured as or otherwise support a means for communicating based on one or more measurements associated with the SSB.

By including or configuring the communications manager 920 in accordance with examples as described herein, the device 905 may support techniques for improved communication reliability, improved power consumption, more efficient utilization of communication resources, improved coordination between devices, longer battery life, improved utilization of processing capability, or any combination thereof. For example, based on the network entity coordinating the active NES with the device 905, the device 905 may perform accurate and efficient SSB measurements based on the active NES. For example, the device 905 may improve a processing overhead and power consumption by performing skipping of SSB measurements, performing SSB measurements according to an increased periodicity, or both. Additionally, or alternatively, the device 905 may support improved measurement accuracy based on using measurement thresholds corresponding to the indicated active NES. The improved measurement accuracy may result in improved cell selection for the device 905.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of SSB procedures based on network power savings as described herein, or the processor 940 and the memory 930 may be otherwise configured to perform or support such operations.

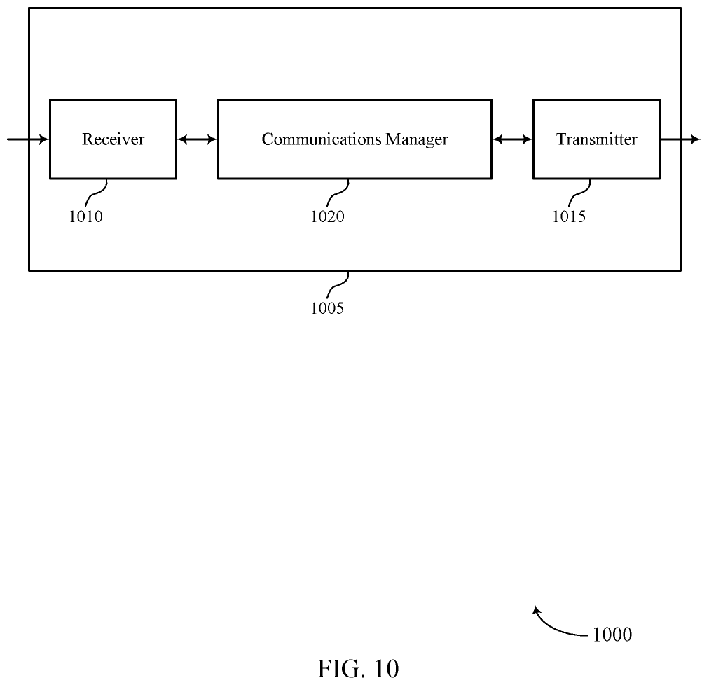

FIG. 10 illustrates a block diagram 1000 of a device 1005 that supports SSB procedures based on network power savings in accordance with one or more aspects of the present disclosure. The device 1005 may be an example of aspects of a network entity 105 as described herein. The device 1005 may include a receiver 1010, a transmitter 1015, and a communications manager 1020, which may be an example of a communications manager 102 as described herein. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of SSB procedures based on network power savings as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 may be configured as or otherwise support a means for outputting, for a UE, an indication of an active NES for a network entity from a set of multiple NESs. The communications manager 1020 may be configured as or otherwise support a means for outputting an SSB for the network entity based on the active NES. The communications manager 1020 may be configured as or otherwise support a means for communicating (e.g., with the UE) based on the SSB.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for an improved processing overhead and improved power consumption for the device 1005. For example, the device 1005 may support the active NES, allowing the device 1005 to reduce a quantity of SSBs transmissions. Reducing the quantity of SSB transmissions may improve the processing overhead and power consumption at the device 1005. Additionally, or alternatively, based on indicating the active NES to a UE 115, the device 1005 may improve the coordination with the UE 115, improving the accuracy of cell selection or reselection procedures at the UE 115. Accordingly, the device 1005 may improve the processing overhead and power consumption associated with cell selection and reselection procedures for UEs 115.

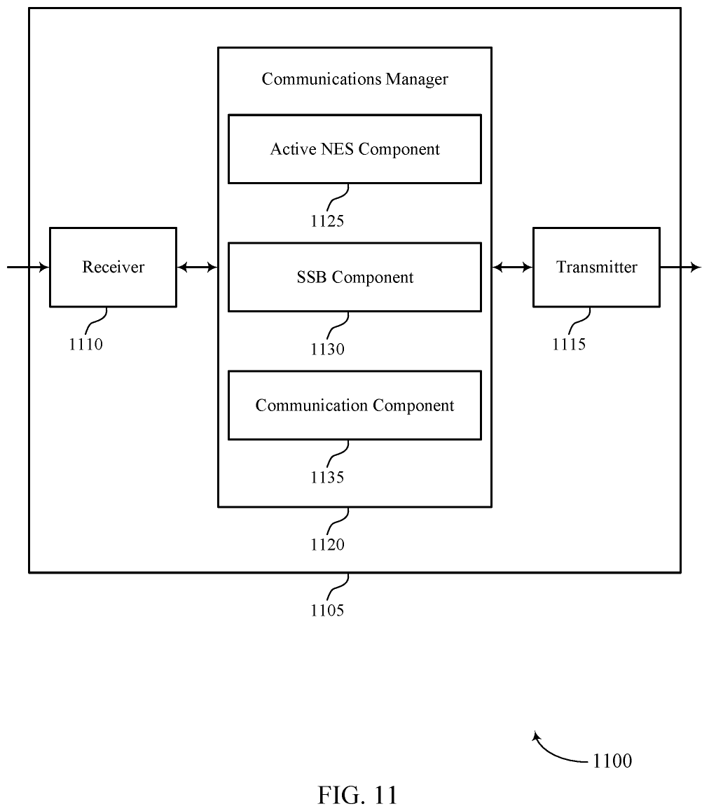

FIG. 11 illustrates a block diagram 1100 of a device 1105 that supports SSB procedures based on network power savings in accordance with one or more aspects of the present disclosure. The device 1105 may be an example of aspects of a device 1005 or a network entity 105 as described herein. The device 1105 may include a receiver 1110, a transmitter 1115, and a communications manager 1120, which may be an example of a communications manager 102 as described herein. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of SSB procedures based on network power savings as described herein. For example, the communications manager 1120 may include an active NES component 1125, an SSB component 1130, a communication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The active NES component 1125 may be configured as or otherwise support a means for outputting, for a UE, an indication of an active NES for a network entity from a set of multiple NESs. The SSB component 1130 may be configured as or otherwise support a means for outputting an SSB for the network entity based on the active NES. The communication component 1135 may be configured as or otherwise support a means for communicating based on the SSB.

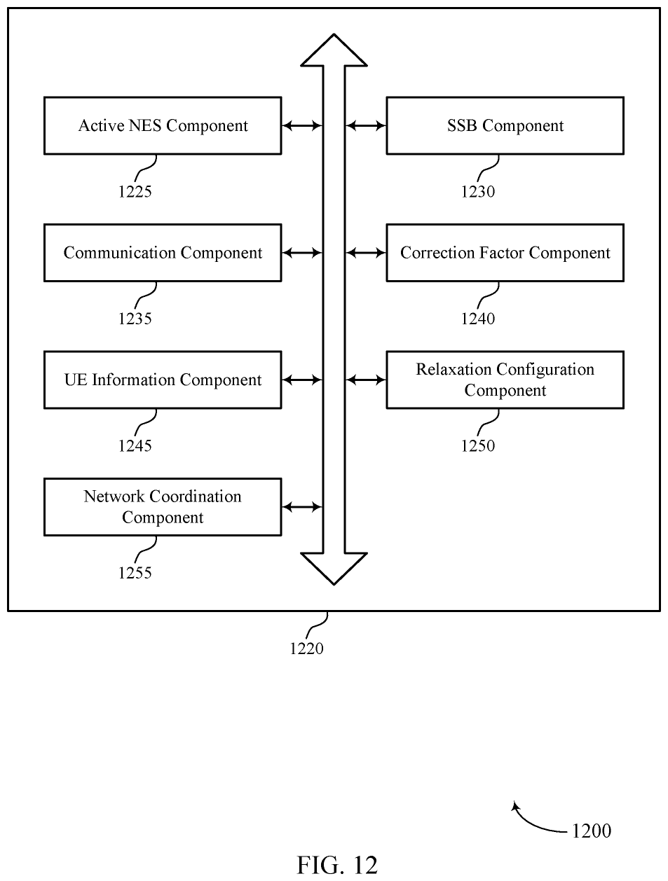

FIG. 12 illustrates a block diagram 1200 of a communications manager 1220 that supports SSB procedures based on network power savings in accordance with one or more aspects of the present disclosure. The communications manager 1220 may be an example of aspects of a communications manager 102, a communications manager 1020, a communications manager 1120, or some combination thereof, as described herein. The communications manager 1220, or various components thereof, may be an example of means for performing various aspects of SSB procedures based on network power savings as described herein. For example, the communications manager 1220 may include an active NES component 1225, an SSB component 1230, a communication component 1235, a correction factor component 1240, a UE information component 1245, a relaxation configuration component 1250, a network coordination component 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The active NES component 1225 may be configured as or otherwise support a means for outputting, for a UE, an indication of an active NES for a network entity from a set of multiple NESs. The SSB component 1230 may be configured as or otherwise support a means for outputting an SSB for the network entity based on the active NES. The communication component 1235 may be configured as or otherwise support a means for communicating based on the SSB.

In some examples, the correction factor component 1240 may be configured as or otherwise support a means for outputting, for the UE, a second indication of a correction factor for a radio measurement threshold that corresponds to the active NES. In some examples, the correction factor component 1240 may be configured as or otherwise support a means for outputting, for the UE, a first signal that indicates a list of correction factors. In some examples, the correction factor component 1240 may be configured as or otherwise support a means for outputting, for the UE, a second signal that includes the second indication of the correction factor from the list of correction factors. In some examples, the UE may be an example of a first UE and the list of correction factors may be an example of a first list with a first list size. In some examples, the correction factor component 1240 may be configured as or otherwise support a means for outputting, for a second UE, a third signal that indicates a second list of correction factors with a second list size different from the first list size. In some examples, the first signal includes an RRC signal, a MIB, a SIB, a RACH signal, or a combination thereof. In some examples, the second signal includes a MAC-CE, a DCI signal, or both.

In some examples, to output the SSB, the SSB component 1230 may be configured as or otherwise support a means for outputting the SSB based on a periodicity for SSBs, a skipping pattern for the SSBs, a first set of SSB occasions to skip, a second set of SSB occasions to transmit, or a combination thereof that corresponds to the active NES.

In some examples, the UE information component 1245 may be configured as or otherwise support a means for obtaining UE information for the UE. In some examples, the UE information component 1245 may be configured as or otherwise support a means for determining the active NES, a radio measurement configuration for the network entity, or both based on the UE information. In some examples, the UE information includes a UE capability, a UE type, UE mobility information, a UE power state, a power saving mode, a sleep mode, an RRC state, or a combination thereof.

In some examples, the relaxation configuration component 1250 may be configured as or otherwise support a means for obtaining a second indication of a relaxed measurement configuration for the UE. In some examples, the relaxation configuration component 1250 may be configured as or otherwise support a means for determining the active NES, a radio measurement configuration for the network entity, or both based on the relaxed measurement configuration for the UE.

In some examples, the relaxation configuration component 1250 may be configured as or otherwise support a means for obtaining a request for an RRM relaxation configuration, an RRM relaxation factor, or both for the network entity. In some examples, the relaxation configuration component 1250 may be configured as or otherwise support a means for determining the active NES, a radio measurement configuration for the network entity, or both based on the request.

In some examples, the active NES component 1225 may be configured as or otherwise support a means for determining a quantity of active antennas, a transmit power, or both for the network entity based on the active NES.

In some examples, the network coordination component 1255 may be configured as or otherwise support a means for obtaining, for a second network entity, a second active NES, a correction factor for a radio measurement threshold that corresponds to the second network entity, or both. In some examples, the network coordination component 1255 may be configured as or otherwise support a means for outputting, for the UE, a second indication of the second active NES, the correction factor, or both for the second network entity, where the second network entity includes a non-serving network entity for the UE.

In some examples, the network coordination component 1255 may be configured as or otherwise support a means for outputting, for a second network entity, the active NES, a correction factor for a radio measurement threshold that corresponds to the network entity, or both.

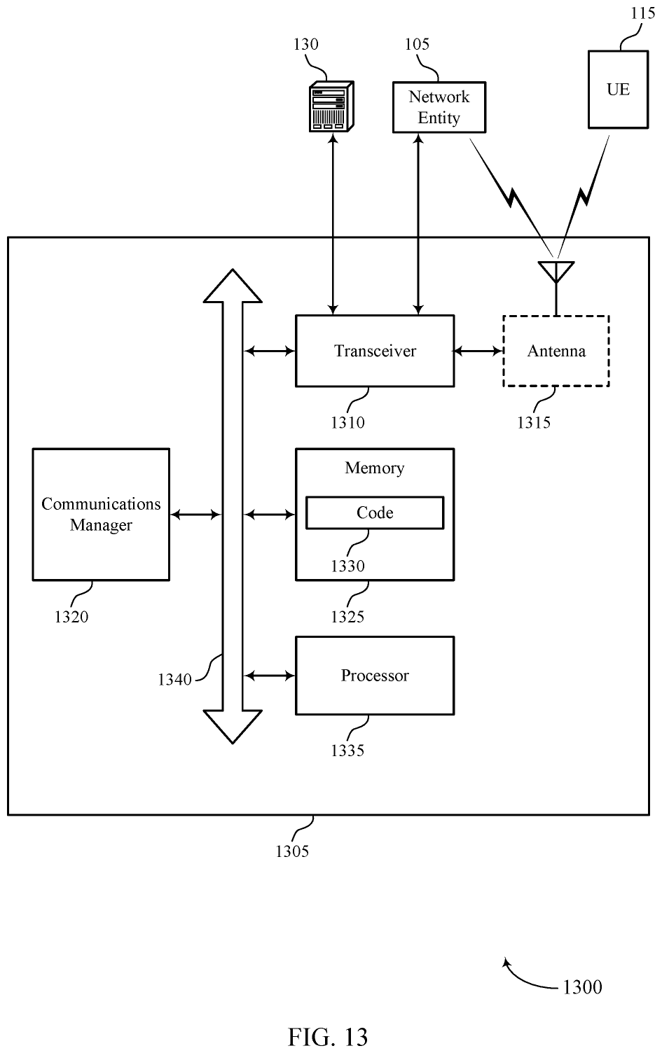

FIG. 13 illustrates a diagram of a system 1300 including a device 1305 that supports SSB procedures based on network power savings in accordance with one or more aspects of the present disclosure. The device 1305 may be an example of or include the components of a device 1005, a device 1105, or a network entity 105 (e.g., a CU, a DU, an RU, or some combination thereof) as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof.

In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting SSB procedures based on network power savings). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325).

In some implementations, the processor 1335 may be a component of a processing system. A processing system may refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305.

The processing system of the device 1305 may interface with other components of the device 1305 and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105 and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 may be configured as or otherwise support a means for outputting, for a UE, an indication of an active NES for a network entity from a set of multiple NESs. The communications manager 1320 may be configured as or otherwise support a means for outputting an SSB for the network entity based on the active NES. The communications manager 1320 may be configured as or otherwise support a means for communicating based on the SSB.

By including or configuring the communications manager 1320 in accordance with examples as described herein, the device 1305 may support techniques for improved communication reliability, improved power consumption, more efficient utilization of communication resources, improved coordination between devices, longer battery life, improved utilization of processing capability, or any combination thereof. For example, the device 1305 may operate according to an active NES to improve a processing overhead and power consumption, and the device 1305 may indicate the active NES to one or more UEs 115 for improved coordination between devices within the wireless network.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of SSB procedures based on network power savings as described herein, or the processor 1335 and the memory 1325 may be otherwise configured to perform or support such operations.

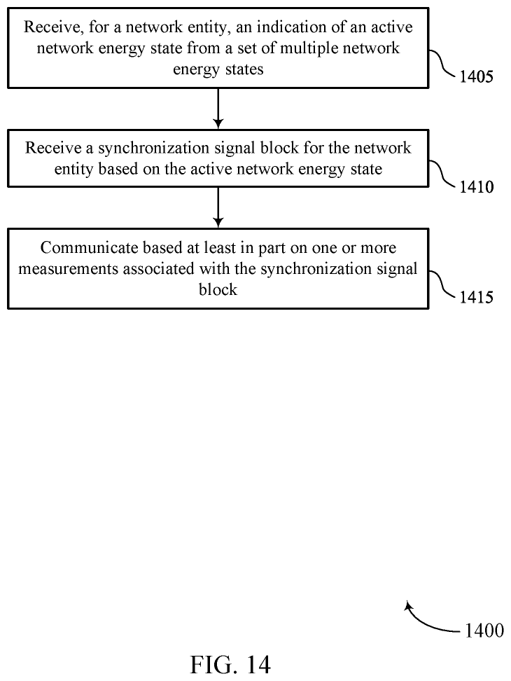

FIG. 14 illustrates a flowchart showing a method 1400 that supports SSB procedures based on network power savings in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, for a network entity, an indication of an active NES from a set of multiple NESs. The operations of 1405 may be performed in accordance with examples as disclosed herein. In some examples, aspects of the operations of 1405 may be performed by an active NES component 825 as described with reference to FIG. 8.

At 1410, the method may include receiving an SSB for the network entity based on the active NES. The operations of 1410 may be performed in accordance with examples as disclosed herein. In some examples, aspects of the operations of 1410 may be performed by an SSB component 830 as described with reference to FIG. 8.

At 1415, the method may include communicating based on one or more measurements associated with the SSB. The operations of 1415 may be performed in accordance with examples as disclosed herein. In some examples, aspects of the operations of 1415 may be performed by a communication component 835 as described with reference to FIG. 8.

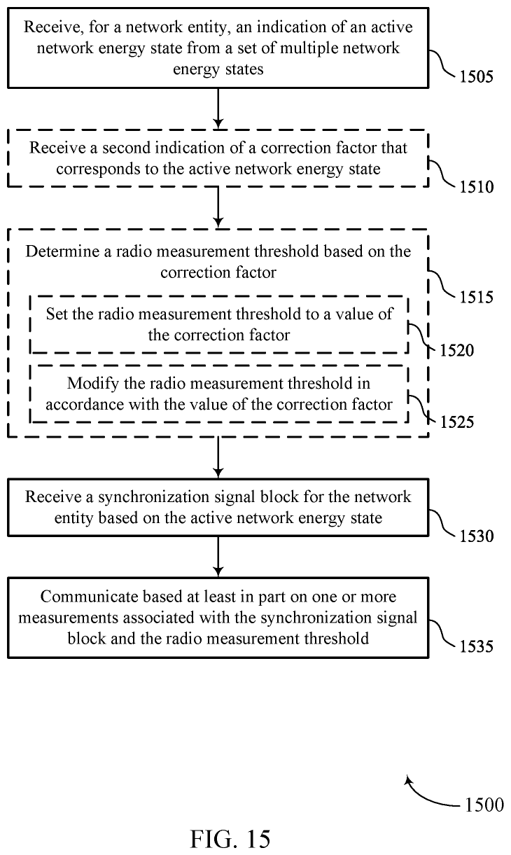

FIG. 15 illustrates a flowchart showing a method 1500 that supports SSB procedures based on network power savings in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, for a network entity, an indication of an active NES from a set of multiple NESs. The operations of 1505 may be performed in accordance with examples as disclosed herein. In some examples, aspects of the operations of 1505 may be performed by an active NES component 825 as described with reference to FIG. 8.

In some examples, at 1510, the method may include receiving a second indication of a correction factor that corresponds to the active NES. The operations of 1510 may be performed in accordance with examples as disclosed herein. In some examples, aspects of the operations of 1510 may be performed by a correction factor component 840 as described with reference to FIG. 8.

In some examples, at 1515, the method may include determining a radio measurement threshold based on the correction factor. The operations of 1515 may be performed in accordance with examples as disclosed herein. In some examples, aspects of the operations of 1515 may be performed by a correction factor component 840 as described with reference to FIG. 8.

In some cases, at 1520, to determine the radio measurement threshold, the method may include setting the radio measurement threshold to a value of the correction factor. The operations of 1520 may be performed in accordance with examples as disclosed herein. In some examples, aspects of the operations of 1520 may be performed by a correction factor component 840 as described with reference to FIG. 8.

In some other cases, at 1525, to determine the radio measurement threshold, the method may include modifying the radio measurement threshold in accordance with the value of the correction factor. The operations of 1525 may be performed in accordance with examples as disclosed herein. In some examples, aspects of the operations of 1525 may be performed by a correction factor component 840 as described with reference to FIG. 8.

At 1530, the method may include receiving an SSB for the network entity based on the active NES. The operations of 1530 may be performed in accordance with examples as disclosed herein. In some examples, aspects of the operations of 1530 may be performed by an SSB component 830 as described with reference to FIG. 8.

At 1535, the method may include communicating based on one or more measurements associated with the SSB and further based on the radio measurement threshold. For example, the method may include comparing a measurement of the one or more measurements to the radio measurement threshold determined for the active NES. The operations of 1535 may be performed in accordance with examples as disclosed herein. In some examples, aspects of the operations of 1535 may be performed by a communication component 835 as described with reference to FIG. 8.

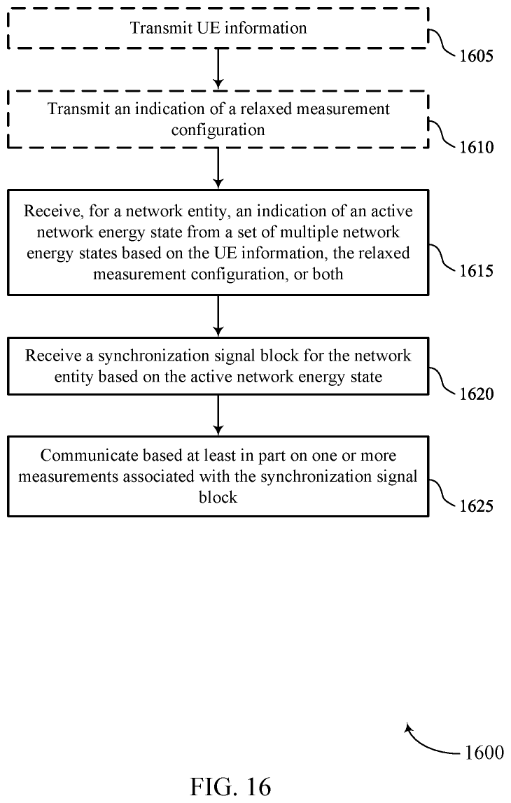

FIG. 16 illustrates a flowchart showing a method 1600 that supports SSB procedures based on network power savings in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

In some examples, at 1605, the method may include transmitting UE information for the UE. The operations of 1605 may be performed in accordance with examples as disclosed herein. In some examples, aspects of the operations of 1605 may be performed by a UE information component 845 as described with reference to FIG. 8.

In some examples, at 1610, the method may include transmitting an indication of a relaxed measurement configuration for the UE. The operations of 1610 may be performed in accordance with examples as disclosed herein. In some examples, aspects of the operations of 1610 may be performed by a relaxation configuration component 850 as described with reference to FIG. 8.

At 1615, the method may include receiving, for a network entity, an indication of an active NES from a set of multiple NESs. The active NES, a radio measurement configuration for the network entity, or both may be based on the UE information, the relaxed measurement configuration for the UE, or both. The operations of 1615 may be performed in accordance with examples as disclosed herein. In some examples, aspects of the operations of 1615 may be performed by an active NES component 825 as described with reference to FIG. 8.

At 1620, the method may include receiving an SSB for the network entity based on the active NES. The operations of 1620 may be performed in accordance with examples as disclosed herein. In some examples, aspects of the operations of 1620 may be performed by an SSB component 830 as described with reference to FIG. 8.

At 1625, the method may include communicating based on one or more measurements associated with the SSB. The operations of 1625 may be performed in accordance with examples as disclosed herein. In some examples, aspects of the operations of 1625 may be performed by a communication component 835 as described with reference to FIG. 8.

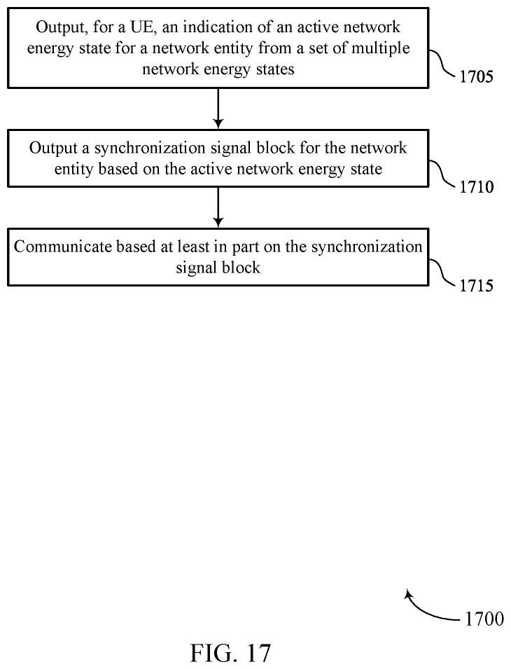

FIG. 17 illustrates a flowchart showing a method 1700 that supports SSB procedures based on network power savings in accordance with one or more aspects of the present disclosure. The operations of the method 1700 may be implemented by a network entity (e.g., an RU, a DU, a CU, or some combination thereof) or its components as described herein. The network entity may be associated with a serving cell for a UE or a non-serving cell (e.g., a neighboring cell) for the UE. The operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting, for a UE, an indication of an active NES for a network entity from a set of multiple NESs. The operations of 1705 may be performed in accordance with examples as disclosed herein. In some examples, aspects of the operations of 1705 may be performed by an active NES component 1225 as described with reference to FIG. 12.

At 1710, the method may include outputting an SSB for the network entity based on the active NES. The operations of 1710 may be performed in accordance with examples as disclosed herein. In some examples, aspects of the operations of 1710 may be performed by an SSB component 1230 as described with reference to FIG. 12.

At 1715, the method may include communicating based on the SSB. The operations of 1715 may be performed in accordance with examples as disclosed herein. In some examples, aspects of the operations of 1715 may be performed by a communication component 1235 as described with reference to FIG. 12.

The following provides an overview of aspects of the present disclosure:

Aspect 1: An apparatus for wireless communications at a UE, comprising: a processor; and memory coupled with the processor, the processor configured to: receive, for a network entity, a first indication of an active network energy state from a plurality of network energy states; receive a synchronization signal block for the network entity based at least in part on the active network energy state; and communicate based at least in part on one or more measurements associated with the synchronization signal block.

Aspect 2: The apparatus of aspect 1, wherein the processor is further configured to: receive a second indication of a correction factor that corresponds to the active network energy state; and determine a radio measurement threshold based at least in part on the correction factor, the communication further based at least in part on the radio measurement threshold.

Aspect 3: The apparatus of aspect 2, wherein, to determine the radio measurement threshold, the processor is configured to: set the radio measurement threshold to a value of the correction factor; or modify the radio measurement threshold in accordance with the value of the correction factor.

Aspect 4: The apparatus of any of aspects 2 through 3, wherein the processor is further configured to: receive a first signal that indicates a list of correction factors; and receive a second signal that comprises the second indication of the correction factor from the list of correction factors.

Aspect 5: The apparatus of aspect 4, wherein the first signal comprises a radio resource control signal, a master information block, a system information block, a random access channel signal, or a combination thereof; and the second signal comprises a medium access channel element, a downlink control information signal, or both.

Aspect 6: The apparatus of any of aspects 2 through 5, wherein the radio measurement threshold comprises a reference signal received power threshold, a reference signal received quality threshold, or both.

Aspect 7: The apparatus of any of aspects 1 through 6, wherein, to receive the synchronization signal block, the processor is configured to: receive the synchronization signal block based at least in part on a periodicity for synchronization signal blocks, a skipping pattern for the synchronization signal blocks, a first set of synchronization signal block occasions to skip, a second set of synchronization signal block occasions to receive, or a combination thereof that corresponds to the active network energy state.

Aspect 8: The apparatus of aspect 7, wherein the processor is further configured to: determine a radio resource management relaxation configuration, a radio resource management relaxation factor, or both based at least in part on the active network energy state, the periodicity for synchronization signal blocks, the skipping pattern for the synchronization signal blocks, the first set of synchronization signal block occasions to skip, the second set of synchronization signal block occasions to receive, or the combination thereof based at least in part on the radio resource management relaxation configuration, the radio resource management relaxation factor, or both.

Aspect 9: The apparatus of any of aspects 1 through 8, wherein the processor is further configured to: transmit UE information, the active network energy state, a radio measurement configuration for the network entity, or both based at least in part on the UE information.

Aspect 10: The apparatus of aspect 9, wherein the UE information comprises a UE capability, a UE type, UE mobility information, a UE power state, a power saving mode, a sleep mode, a radio resource control state, or a combination thereof.

Aspect 11: The apparatus of any of aspects 1 through 10, wherein the processor is further configured to: transmit a third indication of a relaxed measurement configuration for the UE, the active network energy state, a radio measurement configuration for the network entity, or both based at least in part on the relaxed measurement configuration for the UE.

Aspect 12: The apparatus of any of aspects 1 through 11, wherein the processor is further configured to: transmit a request for a radio resource management relaxation configuration, a radio resource management relaxation factor, or both for the network entity, the active network energy state, a radio measurement configuration for the network entity, or both based at least in part on the request.

Aspect 13: The apparatus of any of aspects 1 through 12, wherein the active network energy state indicates a quantity of active antennas, a transmit power, or both for the network entity.

Aspect 14: The apparatus of any of aspects 1 through 13, wherein the network entity comprises a serving network entity.

Aspect 15: The apparatus of any of aspects 1 through 13, wherein the network entity comprises a non-serving network entity; and the first indication of the active network energy state for the non-serving network entity is received from a serving network entity.

Aspect 16: An apparatus for wireless communications, comprising: a processor; and memory coupled with the processor, the processor configured to: output, for a UE, a first indication of an active network energy state for a network entity from a plurality of network energy states; output a synchronization signal block for the network entity based at least in part on the active network energy state; and communicate based at least in part on the synchronization signal block.

Aspect 17: The apparatus of aspect 16, wherein the processor is further configured to: output, for the UE, a second indication of a correction factor for a radio measurement threshold that corresponds to the active network energy state.

Aspect 18: The apparatus of aspect 17, wherein the processor is further configured to: output, for the UE, a first signal that indicates a list of correction factors; and output, for the UE, a second signal that comprises the second indication of the correction factor from the list of correction factors.

Aspect 19: The apparatus of aspect 18, wherein the UE comprises a first UE and the list of correction factors comprises a first list of a first list size, the processor further configured to: output, for a second UE, a third signal that indicates a second list of correction factors of a second list size different from the first list size.

Aspect 20: The apparatus of any of aspects 18 through 19, wherein the first signal comprises a radio resource control signal, a master information block, a system information block, a random access channel signal, or a combination thereof; and the second signal comprises a medium access channel element, a downlink control information signal, or both.

Aspect 21: The apparatus of any of aspects 16 through 20, wherein, to output the synchronization signal block, the processor is configured to: output the synchronization signal block based at least in part on a periodicity for synchronization signal blocks, a skipping pattern for the synchronization signal blocks, a first set of synchronization signal block occasions to skip, a second set of synchronization signal block occasions to transmit, or a combination thereof that corresponds to the active network energy state.

Aspect 22: The apparatus of any of aspects 16 through 21, wherein the processor is further configured to: obtain UE information for the UE; and determine the active network energy state, a radio measurement configuration for the network entity, or both based at least in part on the UE information.

Aspect 23: The apparatus of aspect 22, wherein the UE information comprises a UE capability, a UE type, UE mobility information, a UE power state, a power saving mode, a sleep mode, a radio resource control state, or a combination thereof.

Aspect 24: The apparatus of any of aspects 16 through 23, wherein the processor is further configured to: obtain a third indication of a relaxed measurement configuration for the UE; and determine the active network energy state, a radio measurement configuration for the network entity, or both based at least in part on the relaxed measurement configuration for the UE.

Aspect 25: The apparatus of any of aspects 16 through 24, wherein the processor is further configured to: obtain a request for a radio resource management relaxation configuration, a radio resource management relaxation factor, or both for the network entity; and determine the active network energy state, a radio measurement configuration for the network entity, or both based at least in part on the request.

Aspect 26: The apparatus of any of aspects 16 through 25, wherein the processor is further configured to: determine a quantity of active antennas, a transmit power, or both for the network entity based at least in part on the active network energy state.

Aspect 27: The apparatus of any of aspects 16 through 26, wherein the processor is further configured to: obtain, for a second network entity, a second active network energy state, a correction factor for a radio measurement threshold that corresponds to the second network entity, or both; and output, for the UE, a fourth indication of the second active network energy state, the correction factor, or both for the second network entity, wherein the second network entity comprises a non-serving network entity for the UE.

Aspect 28: The apparatus of any of aspects 16 through 27, wherein the processor is further configured to: output, for a second network entity, the active network energy state, a correction factor for a radio measurement threshold that corresponds to the network entity, or both.

Aspect 29: A method for wireless communications at a UE, comprising: receiving, for a network entity, a first indication of an active network energy state from a plurality of network energy states; receiving a synchronization signal block for the network entity based at least in part on the active network energy state; and communicating based at least in part on one or more measurements associated with the synchronization signal block.

Aspect 30: The method of aspect 29, further comprising: receiving a second indication of a correction factor that corresponds to the active network energy state; and determining a radio measurement threshold based at least in part on the correction factor, the communication further based at least in part on the radio measurement threshold.

Aspect 31: The method of aspect 30, the determining the radio measurement threshold comprising: setting the radio measurement threshold to a value of the correction factor; or modifying the radio measurement threshold in accordance with the value of the correction factor.

Aspect 32: The method of any of aspects 30 through 31, further comprising: receiving a first signal that indicates a list of correction factors; and receiving a second signal that comprises the second indication of the correction factor from the list of correction factors.

Aspect 33: The method of aspect 32, wherein the first signal comprises a radio resource control signal, a master information block, a system information block, a random access channel signal, or a combination thereof; and the second signal comprises a medium access channel element, a downlink control information signal, or both.

Aspect 34: The method of any of aspects 30 through 33, wherein the radio measurement threshold comprises a reference signal received power threshold, a reference signal received quality threshold, or both.

Aspect 35: The method of any of aspects 29 through 34, the receiving the synchronization signal block comprising: receiving the synchronization signal block based at least in part on a periodicity for synchronization signal blocks, a skipping pattern for the synchronization signal blocks, a first set of synchronization signal block occasions to skip, a second set of synchronization signal block occasions to receive, or a combination thereof that corresponds to the active network energy state.

Aspect 36: The method of aspect 35, further comprising: determining a radio resource management relaxation configuration, a radio resource management relaxation factor, or both based at least in part on the active network energy state, the periodicity for synchronization signal blocks, the skipping pattern for the synchronization signal blocks, the first set of synchronization signal block occasions to skip, the second set of synchronization signal block occasions to receive, or the combination thereof based at least in part on the radio resource management relaxation configuration, the radio resource management relaxation factor, or both.

Aspect 37: The method of any of aspects 29 through 36, further comprising: transmitting UE information, the active network energy state, a radio measurement configuration for the network entity, or both based at least in part on the UE information.

Aspect 38: The method of aspect 37, wherein the UE information comprises a UE capability, a UE type, UE mobility information, a UE power state, a power saving mode, a sleep mode, a radio resource control state, or a combination thereof.

Aspect 39: The method of any of aspects 29 through 38, further comprising: transmitting a third indication of a relaxed measurement configuration for the UE, the active network energy state, a radio measurement configuration for the network entity, or both based at least in part on the relaxed measurement configuration for the UE.

Aspect 40: The method of any of aspects 29 through 39, further comprising: transmitting a request for a radio resource management relaxation configuration, a radio resource management relaxation factor, or both for the network entity, the active network energy state, a radio measurement configuration for the network entity, or both based at least in part on the request.

Aspect 41: The method of any of aspects 29 through 40, wherein the active network energy state indicates a quantity of active antennas, a transmit power, or both for the network entity.

Aspect 42: The method of any of aspects 29 through 41, wherein the network entity comprises a serving network entity.

Aspect 43: The method of any of aspects 29 through 41, wherein the network entity comprises a non-serving network entity; and the first indication of the active network energy state for the non-serving network entity is received from a serving network entity.

Aspect 44: A method for wireless communications, comprising: outputting, for a UE, a first indication of an active network energy state for a network entity from a plurality of network energy states; outputting a synchronization signal block for the network entity based at least in part on the active network energy state; and communicating based at least in part on the synchronization signal block.

Aspect 45: The method of aspect 44, further comprising: outputting, for the UE, a second indication of a correction factor for a radio measurement threshold that corresponds to the active network energy state.

Aspect 46: The method of aspect 45, further comprising: outputting, for the UE, a first signal that indicates a list of correction factors; and outputting, for the UE, a second signal that comprises the second indication of the correction factor from the list of correction factors.

Aspect 47: The method of aspect 46, wherein the UE comprises a first UE and the list of correction factors comprises a first list of a first list size, and the method further comprises: outputting, for a second UE, a third signal that indicates a second list of correction factors of a second list size different from the first list size.

Aspect 48: The method of any of aspects 46 through 47, wherein the first signal comprises a radio resource control signal, a master information block, a system information block, a random access channel signal, or a combination thereof; and the second signal comprises a medium access channel element, a downlink control information signal, or both.

Aspect 49: The method of any of aspects 44 through 48, the outputting the synchronization signal block comprising: outputting the synchronization signal block based at least in part on a periodicity for synchronization signal blocks, a skipping pattern for the synchronization signal blocks, a first set of synchronization signal block occasions to skip, a second set of synchronization signal block occasions to transmit, or a combination thereof that corresponds to the active network energy state.

Aspect 50: The method of any of aspects 44 through 49, further comprising: obtaining UE information for the UE; and determining the active network energy state, a radio measurement configuration for the network entity, or both based at least in part on the UE information.

Aspect 51: The method of aspect 50, wherein the UE information comprises a UE capability, a UE type, UE mobility information, a UE power state, a power saving mode, a sleep mode, a radio resource control state, or a combination thereof.

Aspect 52: The method of any of aspects 44 through 51, further comprising: obtaining a third indication of a relaxed measurement configuration for the UE; and determining the active network energy state, a radio measurement configuration for the network entity, or both based at least in part on the relaxed measurement configuration for the UE.

Aspect 53: The method of any of aspects 44 through 52, further comprising: obtaining a request for a radio resource management relaxation configuration, a radio resource management relaxation factor, or both for the network entity; and determining the active network energy state, a radio measurement configuration for the network entity, or both based at least in part on the request.

Aspect 54: The method of any of aspects 44 through 53, further comprising: determining a quantity of active antennas, a transmit power, or both for the network entity based at least in part on the active network energy state.

Aspect 55: The method of any of aspects 44 through 54, further comprising: obtaining, for a second network entity, a second active network energy state, a correction factor for a radio measurement threshold that corresponds to the second network entity, or both; and outputting, for the UE, a fourth indication of the second active network energy state, the correction factor, or both for the second network entity, wherein the second network entity comprises a non-serving network entity for the UE.

Aspect 56: The method of any of aspects 44 through 55, further comprising: outputting, for a second network entity, the active network energy state, a correction factor for a radio measurement threshold that corresponds to the network entity, or both.

Aspect 57: An apparatus for wireless communications at a UE, comprising at least one means for performing a method of any of aspects 29 through 43.

Aspect 58: A non-transitory computer-readable medium storing code for wireless communications at a UE, the code comprising instructions executable by a processor to perform a method of any of aspects 29 through 43.

Aspect 59: An apparatus for wireless communications, comprising at least one means for performing a method of any of aspects 44 through 56.

Aspect 60: A non-transitory computer-readable medium storing code for wireless communications, the code comprising instructions executable by a processor to perform a method of any of aspects 44 through 56.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor; and
memory coupled with the processor, the processor configured to:
receive, for a network entity, a first indication of an active network energy state from a plurality of network energy states;
receive a synchronization signal block for the network entity based at least in part on the active network energy state; and
communicate based at least in part on one or more measurements associated with the synchronization signal block.

2. The apparatus of claim 1, wherein the processor is further configured to:
receive a second indication of a correction factor that corresponds to the active network energy state; and
determine a radio measurement threshold based at least in part on the correction factor, the communication further based at least in part on the radio measurement threshold.

3. The apparatus of claim 2, wherein, to determine the radio measurement threshold, the processor is configured to:
set the radio measurement threshold to a value of the correction factor; or
modify the radio measurement threshold in accordance with the value of the correction factor.

4. The apparatus of claim 2, wherein the processor is further configured to:
receive a first signal that indicates a list of correction factors; and
receive a second signal that comprises the second indication of the correction factor from the list of correction factors.

5. The apparatus of claim 4, wherein:
the first signal comprises a radio resource control signal, a master information block, a system information block, a random access channel signal, or a combination thereof; and
the second signal comprises a medium access channel element, a downlink control information signal, or both.

6. The apparatus of claim 2, wherein the radio measurement threshold comprises a reference signal received power threshold, a reference signal received quality threshold, or both.

7. The apparatus of claim 1, wherein, to receive the synchronization signal block, the processor is configured to:
receive the synchronization signal block based at least in part on a periodicity for synchronization signal blocks, a skipping pattern for the synchronization signal blocks, a first set of synchronization signal block occasions to skip, a second set of synchronization signal block occasions to receive, or a combination thereof that corresponds to the active network energy state.

8. The apparatus of claim 7, wherein the processor is further configured to:
determine a radio resource management relaxation configuration, a radio resource management relaxation factor, or both based at least in part on the active network energy state,
the periodicity for synchronization signal blocks, the skipping pattern for the synchronization signal blocks, the first set of synchronization signal block occasions to skip, the second set of synchronization signal block occasions to receive, or the combination thereof based at least in part on the radio resource management relaxation configuration, the radio resource management relaxation factor, or both.

9. The apparatus of claim 1, wherein the processor is further configured to:
transmit UE information,
the active network energy state, a radio measurement configuration for the network entity, or both based at least in part on the UE information.

10. The apparatus of claim 9, wherein the UE information comprises a UE capability, a UE type, UE mobility information, a UE power state, a power saving mode, a sleep mode, a radio resource control state, or a combination thereof.

11. The apparatus of claim 1, wherein the processor is further configured to:
transmit a third indication of a relaxed measurement configuration for the UE,
the active network energy state, a radio measurement configuration for the network entity, or both based at least in part on the relaxed measurement configuration for the UE.

12. The apparatus of claim 1, wherein the processor is further configured to:
transmit a request for a radio resource management relaxation configuration, a radio resource management relaxation factor, or both for the network entity,
the active network energy state, a radio measurement configuration for the network entity, or both based at least in part on the request.

13. The apparatus of claim 1, wherein the active network energy state indicates a quantity of active antennas, a transmit power, or both for the network entity.

14. The apparatus of claim 1, wherein the network entity comprises a serving network entity.

15. The apparatus of claim 1, wherein:
the network entity comprises a non-serving network entity; and
the first indication of the active network energy state for the non-serving network entity is received from a serving network entity.

16. An apparatus for wireless communications, comprising:
a processor; and
memory coupled with the processor, the processor configured to:
output, for a user equipment (UE), a first indication of an active network energy state for a network entity from a plurality of network energy states;
output a synchronization signal block for the network entity based at least in part on the active network energy state; and
communicate based at least in part on the synchronization signal block.

17. The apparatus of claim 16, wherein the processor is further configured to:
output, for the UE, a second indication of a correction factor for a radio measurement threshold that corresponds to the active network energy state.

18. The apparatus of claim 17, wherein the processor is further configured to:
output, for the UE, a first signal that indicates a list of correction factors; and
output, for the UE, a second signal that comprises the second indication of the correction factor from the list of correction factors.

19. The apparatus of claim 18, wherein the UE comprises a first UE and the list of correction factors comprises a first list of a first list size, the processor further configured to:
output, for a second UE, a third signal that indicates a second list of correction factors of a second list size different from the first list size.

20. The apparatus of claim 18, wherein:
the first signal comprises a radio resource control signal, a master information block, a system information block, a random access channel signal, or a combination thereof; and
the second signal comprises a medium access channel element, a downlink control information signal, or both.

21. The apparatus of claim 16, wherein, to output the synchronization signal block, the processor is configured to:
output the synchronization signal block based at least in part on a periodicity for synchronization signal blocks, a skipping pattern for the synchronization signal blocks, a first set of synchronization signal block occasions to skip, a second set of synchronization signal block occasions to transmit, or a combination thereof that corresponds to the active network energy state.

22. The apparatus of claim 16, wherein the processor is further configured to:
obtain UE information for the UE; and
determine the active network energy state, a radio measurement configuration for the network entity, or both based at least in part on the UE information.

23. The apparatus of claim 22, wherein the UE information comprises a UE capability, a UE type, UE mobility information, a UE power state, a power saving mode, a sleep mode, a radio resource control state, or a combination thereof.

24. The apparatus of claim 16, wherein the processor is further configured to:
obtain a third indication of a relaxed measurement configuration for the UE; and
determine the active network energy state, a radio measurement configuration for the network entity, or both based at least in part on the relaxed measurement configuration for the UE.

25. The apparatus of claim 16, wherein the processor is further configured to:
obtain a request for a radio resource management relaxation configuration, a radio resource management relaxation factor, or both for the network entity; and
determine the active network energy state, a radio measurement configuration for the network entity, or both based at least in part on the request.

26. The apparatus of claim 16, wherein the processor is further configured to:
determine a quantity of active antennas, a transmit power, or both for the network entity based at least in part on the active network energy state.

27. The apparatus of claim 16, wherein the processor is further configured to:
obtain, for a second network entity, a second active network energy state, a correction factor for a radio measurement threshold that corresponds to the second network entity, or both; and
output, for the UE, a fourth indication of the second active network energy state, the correction factor, or both for the second network entity, wherein the second network entity comprises a non-serving network entity for the UE.

28. The apparatus of claim 16, wherein the processor is further configured to:
output, for a second network entity, the active network energy state, a correction factor for a radio measurement threshold that corresponds to the network entity, or both.

29. A method for wireless communications at a user equipment (UE), comprising:
receiving, for a network entity, a first indication of an active network energy state from a plurality of network energy states;
receiving a synchronization signal block for the network entity based at least in part on the active network energy state; and
communicating based at least in part on one or more measurements associated with the synchronization signal block.

30. A method for wireless communications, comprising:
outputting, for a user equipment (UE), a first indication of an active network energy state for a network entity from a plurality of network energy states;
outputting a synchronization signal block for the network entity based at least in part on the active network energy state; and
communicating based at least in part on the synchronization signal block.
